(19) United States
(12) Patent Application Publication
(10) Pub. No.: US 2026/0050090 A1
(43) Pub. Date: Feb. 19, 2026

(54) Underwater Navigation Based on Light Polarization Mapping

(71) Applicant: ARIZONA BOARD OF REGENTS ON BEHALF OF ARIZONA STATE UNIVERSITY, Scottsdale, AZ (US)

(72) Inventors: Yu Yao, Chandler, AZ (US); Jing Bai, San Jose, CA (US); Md Zubair Ebne Rafique, Gilbert, AZ (US); Jiawei Zuo, Redmond, WA (US)

(73) Assignee: ARIZONA BOARD OF REGENTS ON BEHALF OF ARIZONA STATE UNIVERSITY, Scottsdale, AZ (US)

(21) Appl. No.: 19/301,358

(22) Filed: Aug. 15, 2025

Related U.S. Application Data
(60) Provisional application No. 63/683,305, filed on Aug. 15, 2024.

(51) Int. Cl. G01S 19/47; B25J 11/00; B25J 17/02; B63G 8/38; H04N 23/50; H04N 23/51; H04N 23/90

(52) U.S. Cl. CPC G01S 19/47; H04N 23/51; H04N 23/555; H04N 23/90; B25J 11/00; B25J 17/0258; B63B 2213/00; B63G 8/38

(57) ABSTRACT

A polarization-based underwater navigation and global positioning system is disclosed that includes dual polarization cameras comprising a small angle view imaging lens configured to detect full Stokes parameters simultaneously and a computer system programmed with a model for a skylight polarization mapping with a scattering model of light inside turbid water.

### CROSS-REFERENCE TO RELATED APPLICATIONS

This application claims priority to U.S. Patent Provisional Application No. 63/683,305 filed on Aug. 15, 2024, the contents of which are hereby incorporated by reference in its entirety.

### FIELD

The application generally relates to imaging systems, and in particular to a dual-camera full-stokes underwater polarization imaging system for underwater navigation based on light polarization mapping.

### BACKGROUND

Global Positioning System (GPS) provides geolocation to a GPS receiver on or near the Earth, yet it is limited to usage in very shallow water (˜within a few meters) due to the strongly attenuated GPS radio signal in seawater. Acoustic navigation systems can be used in the deep ocean, yet they require predetermined reference locations and are not suitable for long-distance navigation. Underwater magnetic or gyro compass can be used in the deep ocean, yet they require references for error correction and geolocation and are also not suitable for long-distance navigation. Recently underwater polarization light patterns have been proved to serve as a solar compass and can also be used in the marine environment to determine global location. Among these techniques, polarization navigation is the least studied; yet it has attractive advantages over other techniques in the potential long-range geolocation requiring no reference locations and complex systems. Moreover, in natural water bodies, e.g., lakes, seas, and oceans, the water turbidity could result in large measurement errors. Further investigation is essential to improve positioning accuracy and expand overall system capability.

With the vast water body compared to the total landmass on earth, underwater navigation has become essential. However, despite different approaches, there is no reliable method for underwater navigation yet because current technology such as GPS or WiFi does not work very well underwater. Mapping the underwater light polarization is a viable solution to this problem as the map of the polarization state of light, coming from different directions, is dependent on the specific coordinate system connecting the position of the observer and the position of the source, the sun. So, faithfully detecting the sun's position from under the water is essential for underwater navigation.

Automated underwater navigation and positioning systems are vital to nearly all underwater applications because Global Positioning System (GPS) is limited to usage in very shallow seawater (˜within a few meters) due to water absorption. Alternatively, acoustic navigation systems can be applied in the deep ocean; yet they require predetermined reference locations and are not suitable for long-distance navigation. In addition, underwater magnetic or gyro compass can be used in the deep ocean; yet they require references for error correction and geolocation and are also not suitable for long-distance navigation. Recently Underwater polarization light patterns have been proved to serve as a solar compass and can also be used in the marine environment to determine global location. Among these techniques, polarization navigation is the least well-studied; yet it has attractive advantages over other techniques in the potential long-range geolocation requiring no reference locations and complex systems. Moreover, a compact polarization-based navigation device can also be combined with other technologies to mitigate the limitations (e.g., operation depth), improve positioning accuracy and expand overall system capability.

### SUMMARY

According to examples of the present disclosure, a polarization-based navigation and global positioning system in clear and turbid water bodies are disclosed. The disclosed polarization-based underwater navigation and global positioning system can operate in water bodies with different turbidity levels and can be operated over 100 meters below the water surface, much deeper than the underwater depth accessible for the state-of-art GPS system. A comprehensive model for the skylight polarization mapping is provided considering the scattering of light inside the turbid water body. Based on this model, a compact polarization imaging system is provided for global positioning in both swimming pool water and turbid lake water with highly improved accuracy compared with the conventional methods. The polarization-based underwater navigation and global positioning system can operate up to 100 meters in water bodies with different turbidity levels. A model is provided to take into account the impact of scatterers on the polarization-position analysis to minimize the location measurement error. An ultra-compact system is also provided for the polarization global positioning system. This technology enables ultra-compact polarization-based global positioning systems, which can be operated in water down to 100 meters (deeper than satellite GPS) without requiring any reference.

The technology is a polarization-based underwater navigation and global positioning system device. There is currently no reliable method for underwater navigation yet because current technologies such as GPS or WiFi does not work very well underwater. Mapping the underwater light polarization is a viable solution to this problem as the map of the polarization state of light, coming from different directions, is dependent on the specific coordinate system connecting the position of the observer and the position of the source, the sun. The disclosed device comprises a dual polarization camera that employs a small angle of view imaging lens, using a comprehensive model for the skylight polarization mapping considering the scattering of light inside turbid water, and is fully automated. The model takes into account the impact of scatterers on the polarization-position analysis to minimize the location measurement error. The device can be operated in water down to 100 meters (deeper than satellite GPS) without requiring any reference. The device has been tested successfully in a clear pool of water and Tempe Town Lake. The device has a dual polarization camera. The device has high polarization detection accuracy that employs a small angle of view imaging lens to reduce polarization aberration. The device is fully automated. A comprehensive model for the skylight polarization mapping is provided considering the scattering of light inside turbid water.

### BRIEF DESCRIPTION OF THE FIGURES

FIG. 1A, FIG. 1B, FIG. 1C, and FIG. 1D show a full Stokes polarization navigation system configuration according to examples of the present disclosure, where FIG. 1A shows a photo of an underwater polarization imaging system, FIG. 1B shows a 3D schematic of the underwater polarization imaging system, FIG. 1C shows settings of dual DoFP polarization cameras for full Stokes polarization imaging, and FIG. 1D shows an illustration of mapping of the sky polarization by spatial scanning mode.

FIG. 2A shows a measurement setup inside ASU swimming pool (33.415222, −111.931604) according to examples of the present disclosure, FIG. 2B shows an AoP mapping according to examples of the present disclosure, FIG. 2C shows a DoCP mapping of partially polarized light inside swimming pool water, overexposed regions were cropped off (white area) during data processing according to examples of the present disclosure. FIG. 2D shows a fitting AoP mapping result with Rayleigh scattering model according to examples of the present disclosure where the inset shows AoP mapping after removing data corresponding to overexposure and high DoCP, and FIG. 2E shows azimuth angle and FIG. 2F shows zenith angle error for different DoCP limits used to remove data from AoP mapping according to examples of the present disclosure.

FIG. 3A, FIG. 3B, FIG. 3C, FIG. 3D, FIG. 3E show multiple measurements in ASU swimming pool (33.415222, −111.931604) according to examples of the present disclosure, wherein FIG. 3A and FIG. 3B show predicted sun azimuth and zenith angles obtained by fitting the measured data with the present model after removing noise corresponding to DoCP, FIG. 3C and FIG. 3D show predicted longitude and latitude, determined from the extracted sun positions in FIG. 3A and FIG. 3B, and FIG. 3E shows location prediction error (Km) in terms of absolute distance from the actual measurement location.

FIG. 4A, FIG. 4B, FIG. 4C, FIG. 4D, and FIG. 4E show underwater Measurement in Tempe Town Lake Water according to examples of the present disclosure, where FIG. 4A shows a measurement setup, FIG. 4B shows measured AoP on Oct. 11, 2021, FIG. 4C shows fitting it with ST (Skylight Transmission) and SMS (Single and Multiple Scattering) Model at Zenith Angle 44°, FIG. 4D shows fitting error in azimuth angle of the sun position, FIG. 4E shows a fitting error in finding Zenith Angle of the sun.

FIG. 5 shows a flowchart for a method according to examples of the present disclosure.

FIG. 6A, FIG. 6B, and FIG. 6C show the underwater polarization system, respectively, and FIG. 6D and FIG. 6E show plots of zenith and azimuth angle correction, respectively, according to examples of the present disclosure.

FIG. 7A, FIG. 7B, and FIG. 7C shows a simulation of polarization aberration introduced using polarization ray tracing, according to examples of the present disclosure, where FIG. 7A shows a ray diagram of a fisheye lens, FIG. 7B shows an AOP error that is introduced by the fisheye lens (AFOV=180°) at the focal plane as a function of incidence angle and AOP of linearly polarized incident light, and FIG. 7C shows a DOLP error introduced by a fisheye lens) (AFOV=180° at the focal plane as a function of incidence angle and AOP of linearly polarized incident light.

FIG. 8A, FIG. 8B, and FIG. 8C show a simulation of polarization aberration introduced using polarization ray tracing, according to examples of the present disclosure, where FIG. 8A shows a ray diagram of a small AFOV=12° lens, FIG. 8B shows an AOP error introduced at focal plane as a function of incidence angle and AOP of linearly polarized incident light, and FIG. 8C shows a DOLP error introduced at focal plane as a function of incidence angle and AOP of linearly polarized incident light.

FIG. 9 shows a schematic of an experimental setup for measuring Linear polarization extinction ratio (LPER) of Sony IMX MZR250 under oblique incidence, according to examples of the present disclosure.

FIG. 10 shows a plot of LPER of Sony IMX 250MZR as a function of incidence angle according to examples of the present disclosure.

FIG. 11A and FIG. 11B show a theoretical estimated polarization detection error due to limited LPER according to examples of the present disclosure, where FIG. 11A shows a plot of estimated Degree of linear polarization (DOLP) detection error vs. incidence angle and FIG. 11B shows a plot of angle of polarization (AoP) detection error vs. incidence angle.

FIG. 12A, FIG. 12B, FIG. 12C, FIG. 12D, FIG. 12E, and FIG. 12F show schematic of auto polarization mapping; Automatic polarization mapping measurement and simulation in the air according to examples of the present disclosure, where FIG. 12A and FIG. 12B shows measured Angle of polarization (AoP) and Degree of linear polarization (DOLP), respectively, FIG. 12C and FIG. 12D shows simulated AOP and DOLP of the sky at the same time and location, respectively, FIG. 12E shows a plot of linear fitting to calculate solar meridian, and FIG. 12F shows a plot of RMS value of solar meridian calculation of seven measurement.

FIG. 13 shows a flow chart for measured AoP fitting with a mathematical model according to examples of the present disclosure.

FIG. 14A, FIG. 14B, FIG. 14C, FIG. 14D, and FIG. 14E show a cross-section of our polarization measurement tool and calculation of off-center camera correction for zenith and azimuth angles according to examples of the present disclosure.

FIG. 15A and FIG. 15B show aspects of a device for capturing the intensity of light without and with the water tank to set a baseline for measurement, according to examples of the present disclosure. FIG. 15C and FIG. 15D shows aspects of measuring the intensity of light without and with the water tank full of lake water, according to examples of the present disclosure.

FIG. 16 shows a calculation process flow to obtain the particle density according to examples of the present disclosure.

FIG. 17 shows a flow chart of different processes to simulate the polarization mapping from sunlight scattering in underwater with MC Simulation according to examples of the present disclosure.

FIG. 18A, FIG. 18B, FIG. 18C, and FIG. 18D show plots of the number of photons versus number of scattering according to examples of the present disclosure considering polystyrene particles (index, N=1.572) of radius 400 nm and concentration 1.1770e+12 m⁻³, number of scatterings for different depth of water indicated in terms of Mean Free Path (MFP), where FIG. 18A shows 0.1 MFP, FIG. 18B shows 0.5 MFP, FIG. 18C shows 1.0 MFP, and FIG. 18D shows 5.0 MFP.

FIG. 19A shows a plot for particle size distribution and number density in Tempe Town lake water and FIG. 19B shows a plot for scattering probability vs. number of scattering for 1 MFP depth of water according to examples of the present disclosure.

FIG. 20 shows a flowchart for a detailed calculation method of the mathematical model to describe turbid water light polarization according to examples of the present disclosure.

### DETAILED DESCRIPTION

According to examples of the present disclosure, a dual-camera full-stokes underwater polarization imaging system is disclosed that is capable of automatically imaging the whole sky with variable exposer time, high accuracy, high repeatability, and high SNR. With this automatic system, the resulting underwater polarization mapping in swimming pool water provides a sun position error of 0.35° azimuth and 0.03° zenith angle, and the corresponding location prediction error is ˜23 Km. Furthermore, for turbid water the geolocation determination accuracy is ˜100 Km. The present approach to developing this system and the data processing methods may pave the way for future innovation in polarization-based underwater navigation.

Table 1 provides a comparison of different underwater navigation methods.

TABLE 1
A comparison of different underwater navigation techniques

| | | Magnetic | |
|---|---|---|---|
| Navigation | Acoustic | or Gyro | Polarization |
| method | Positioning | compass | Mapping |
| Require reference | Yes | No | No |
| for navigation | | | |
| Operation depth | Up to 10 km | No Limitation | Up to >200 m |
| | | | in theory; 20 m |
| | | | (demonstrated) |
| Position Accuracy | 0.3~2.0 m | Angle accuracy | 60 km(geolocal- |
| | | 1~3° | ization) or 6 m |
| | | | for every 1 km |
| | | | traveled |
| Suitable for long- | Require | Require | Yes |
| range | reference | reference | |
| geolocalization | locations | locations | |
| System | Accurate position | Compact | Compact |
| compactness | requires complex | | |
| | systems with pre- | | |
| | installed | | |
| | transponder array | | |

In fact, skylight polarization has been applied for navigation in nature, especially among insects such as ants and beetles etc. There are quite a few demonstrations of skylight polarization-based navigation in modern times in terrestrial environments in the past decades. Yet, polarization navigation in marine environments is much more challenging than skylight polarization navigation in the terrestrial environment. The progress of polarization-based navigation in the marine environment is left behind both by skylight navigation in the terrestrial environment and other marine navigation techniques. In one of the recent demonstrations, using a manual rotation polarization camera mounted on a tripod in water depth within 2 to 20 m, sun azimuth and elevation angle determination with RMS error of 8.57° and 5.82° respectively and global position error of 817 Km (when the sun elevation was more than 40°) is reported. Further processing of the data with the kNN regression model reduced the error to 6.02°, 2.92°, and 422 Km, respectively. When sun elevation was below 40°, they obtained an RMS error of 5.46°, 6.23°, and 1970 Km, respectively, for sun azimuth, elevation, and global positioning (with kNN regression). Continuous measurement showed their capability to distinguish between two consecutive global positions is around 61 Km on average (or 6 m error for every 1 Km travel). They used a theoretical model considering sunlight refraction and single Rayleigh scattering inside the water to determine the sun and global positions from the measurement. In another more recent demonstration, continuous measurements were done inside a pool of clean water (depth 1.5 m, instrument height unknown) using an underwater system composing a linear polarization (LP) camera assembled with a fisheye lens. RMS error of the solar zenith and azimuth angle tracking was 0.3° and 1.3° respectively, obtained using a theoretical model considering single-Rayleigh scattering of sunlight in air and refraction of the skylight into water. However, the performance of state-of-art polarization-based navigation systems especially position accuracy and operation speed, are insufficient for practical applications. Besides, these systems all require manual operation to perform polarization mapping, cither by manually rotating the polarization camera or putting on a mask to block sun's direct incidence.

According to examples of the present disclosure, an automated underwater imaging system is described. The advantages of the present system can be summarized into three main categories: First, the present system has a dual polarization camera, which can detect full Stokes parameters simultaneously. Secondly, the present system has high polarization detection accuracy as it is employed in a small angle of view imaging lens to reduce polarization aberration. Thirdly, the present system is fully automated; The camera exposure can be automatically adjusted during mapping. Therefore, no manual operation is required to block sun's direct incidence.

Navigation and location determination based on light polarization mapping under several different environments is also described: from a terrestrial environment to clean water in the water bucket, swimming pool, and highly turbid lake water. The resulting underwater polarization mapping, with this automatic system, in clear swimming pool water provides a sun position error of 0.35° azimuth and 0.03° zenith angle, and the corresponding location prediction error is ˜23 Km. For more turbid lake waters with large number of scatters the navigation and geolocation determination error is ˜100 Km.

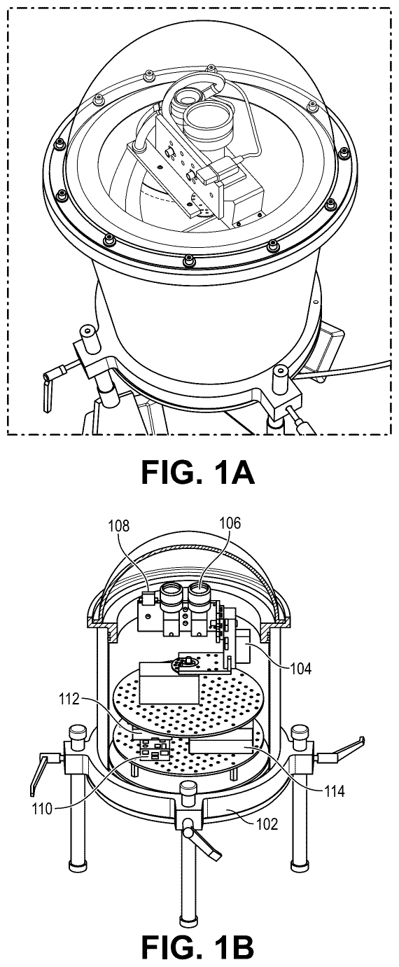

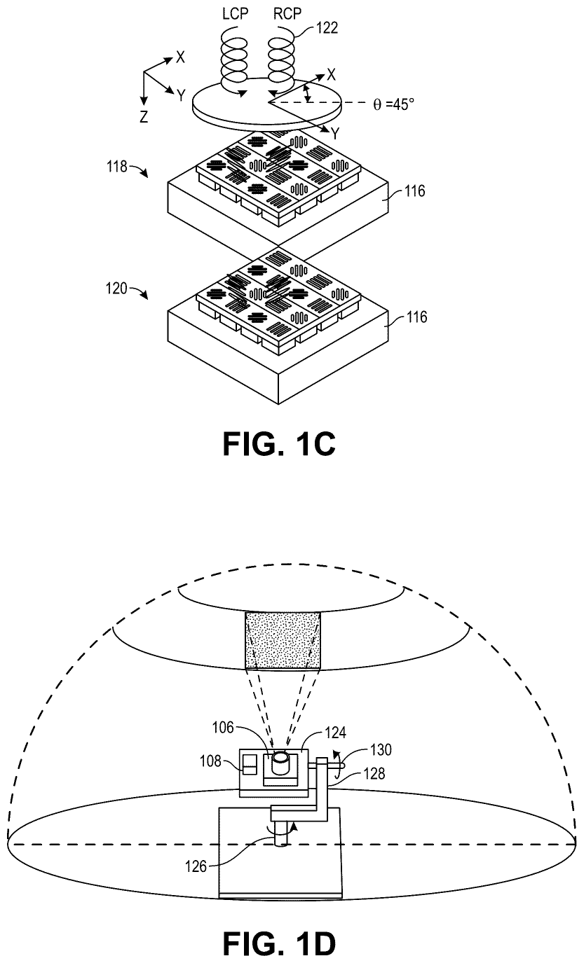

FIG. 1A, FIG. 1B, FIG. 1C, and FIG. 1D show a full Stokes polarization navigation system configuration according to examples of the present disclosure, where FIG. 1A shows a photo of an underwater polarization imaging system, FIG. 1B shows a 3D schematic of the underwater polarization imaging system, FIG. 1C shows settings of dual DoFP polarization cameras for full Stokes polarization imaging, and FIG. 1D shows an illustration of mapping of the sky polarization by spatial scanning mode.

The underwater polarization imaging comprises an underwater housing 102 and a full Stokes polarization mapping system (FSPMS) as shown in FIG. 1A. The underwater housing 102 has a 14-inch diameter transparent half-sphere dome for upwards imaging. FIG. 1B shows the 3D section view of the system to reveal the details of the FSPMS, which is assembled inside the underwater housing 102. FSPMS comprises a robotic arm 104 with 2 degrees of freedom, the elevation arm movement covers zenith angle from 0° to 90°; beneath the elevation arm lies a rotation base for 360° azimuth scanning. Dual polarization cameras 106 are mounted side-by-side on the elevation arm for full Stokes polarization mapping and imaging underwater, for each camera small field of view (FOV) of 14.3°×10.8°. An industrial attitude and heading reference system (AHRS) (3DM-GX5-25) 108 is mounted nearby dual polarization camera 106 (e.g., circular polarized (CP) camera 118 and linearly polarized (LP) camera 120) to indicate camera pointing direction with an accuracy of ±1° in azimuth with respect to geographic (true) North. A Raspberry Pi 4B microcomputer 110 is applied as a local control unit, that is powered by a battery 114, for the rotation of the robotic arms 104, imaging of dual polarization camera 106 and reading from AHRS 108. The local control unit can be commanded by a remote controller which is outside of the underwater housing 102. The cameras, local controller, and remote controller communicate with each other through ethernet cables using Ethernet switch 112. 3D schematic of dual polarization camera settings is shown in FIG. 1C, comprising a LP camera 120 and a CP camera 118 where the LP camera 120 captures the polarization information for linearly polarized light, and the CP camera 118 captures the polarization information of the CP light. Pixelated Al nanogratings array are directly integrated into CMOS imaging sensor to measure S₀, S₁, and S₂ (Sony IMX250MZR 116). In addition, an achromatic quarter waveplate 122 is assembled in front of one sensor (left), with a fast axis aligned at 45° to measure S₃ of incoming light. The imaging speed, resolution, and exposure of the two polarization cameras 106 are kept the same during measurement. A small angular field of view (AFOV) of 14.3°×10.8° imaging lens was applied for both cameras to decrease the polarization aberration and thereby increase the mapping accuracy. FSPMS performs full-sky mapping in a spatial scanning manner, as illustrated in FIG. 1D using a holding plate 124, a first motor 126, a L-shaped arm 128 of the robotic arm 104, and a second motor 130. Each time, local control unit first commands the elevation arm to fix at zenith angle of 8° and let rotation base continuously scans 360° in azimuth. Then the elevation arm zenith angle is increased by 8° to iterate another round of 360° rotation. Full sky mapping can then be stitched together using stitching algorithms. It is noteworthy that two different types of imaging mode are developed to cope with different environments. In low light conditions, the dual polarization camera can operate either at ‘Photo mode’, where dual polarization camera captures images every 8° in azimuth, then the rotation base will rotate to the next azimuth angle and wait until image capturing is finished. This mode is developed for cases where long exposure times are needed, for underwater environment. When light intensity is sufficient, dual polarization camera can operate at ‘video mode’, where dual polarization camera lively captures the polarization image while the rotation base rotates nonstop for 360°. For both imaging mode, the images were saved during imaging and later stitched to full-sky polarization mapping. Each image exposure is automatically adjusted to obtain the highest signal-to-noise ratio (SNR).

Next, the considerations in the design of FSPMS are discussed. Previous works on sky polarization mapping systems often use large angular field of view (AFOV) lenses such as the fisheye lens for polarization mapping. However, the polarization aberration introduced by fisheye lenses is often ignored, which can lead to degradation in the polarization navigation accuracy. Besides, due to strong brightness along the sun's direct incidence direction, a small object is often needed to manually block the sun in the imaging scene to avoid overexposure issues, or mapping needs to be done only at time when the sun is at the edge of the images, i.e., sunrise or sundown. This makes fully automatic polarization mapping and navigation difficult and greatly limits the time of the system can be applied. To address issues mentioned above, two aspects are considered into the design of the present system: First, an imaging lens of a small AFOV of 14.3°×10.8° is applied on polarization cameras, which introduces much less polarization aberration compared to fisheye lens (see below for an exemplar comparison of polarization aberration of small AFOV lens and fisheye lens). Subsequently, a mapping approach based on spatial scanning is applied, thus the exposure close to the sun can be automatically adjusted accordingly to minimize the impact of the sun's direct incidence on polarization mapping and no manual blocking of the sun is required. Besides, the polarization detection accuracy of DoFP polarization imaging sensor (Sony IMX250MZR) at different oblique incidence angles is evaluated as it determines the polarization mapping accuracy. The experimental setup and measurement result are shown and described below. The nanogratings filters have the best optical performance, i.e., linear polarization extinction ratio (LPER) above 100 with normal incidence. However, the performance degraded fast with increasing incidence angle. For example, the LPER of the nanogratings becomes smaller than 50 when the incident angle is larger than 10 degrees. Since the measurement accuracy of the Stokes parameters is directly determined by the LPER of the imaging system, the measurement error for degree of linear polarization (DOLP) and angle of polarization (AOP) increases as the LPER decreases. A detailed polarization detection error estimation is discussed further below. To maintain DOLP measurement error less than 0.05 and AOP error less than 0.2 degrees, LPER better than 50, i.e., incident angle smaller than 10 degrees is required. Due to this degradation of performance, it would be desirable to use a lens with a smaller AFOV, limiting the incident angle of light and improving the measurement accuracy of the polarization states.

### Underwater Polarization Navigation in Swimming Pool

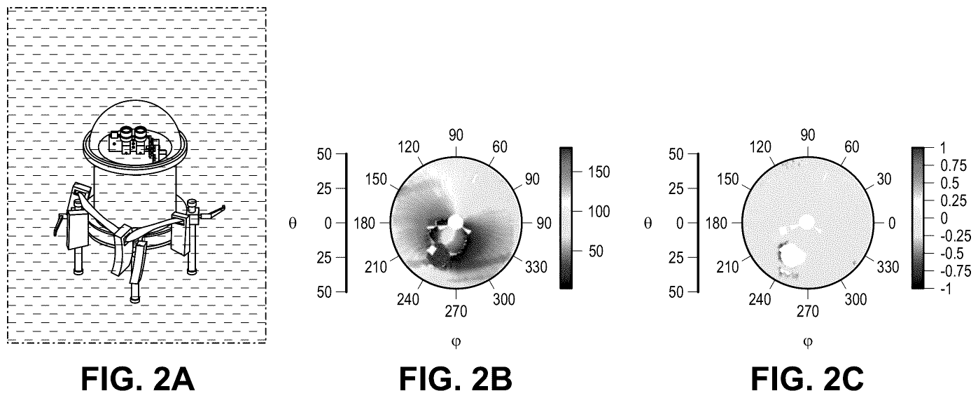

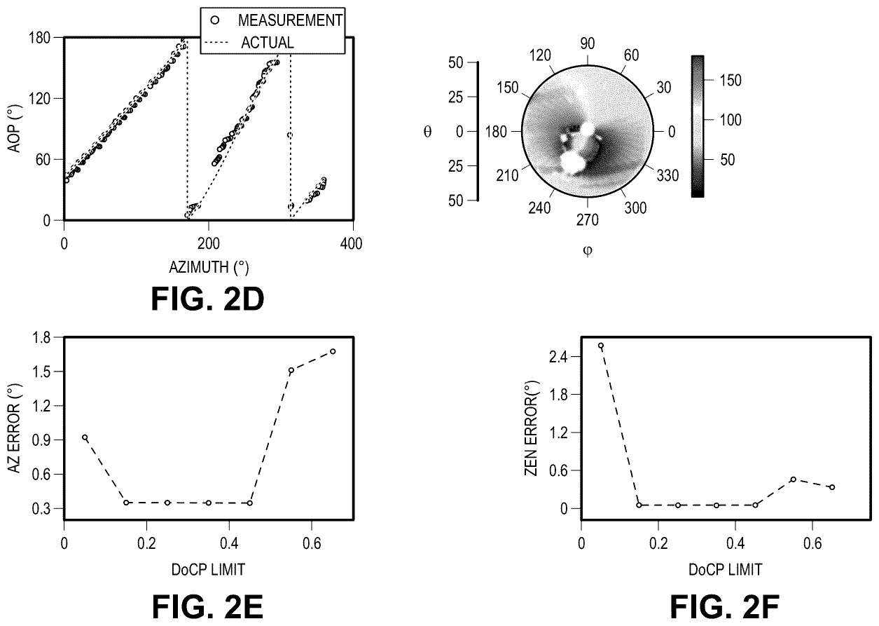

FIG. 2A shows a measurement setup inside ASU swimming pool (33.415222, −111.931604) according to examples of the present disclosure, FIG. 2B shows an AoP mapping according to examples of the present disclosure, FIG. 2C shows a DoCP mapping of partially polarized light inside swimming pool water, overexposed regions were cropped off (white area) during data processing according to examples of the present disclosure. FIG. 2D shows a fitting AoP mapping result with Rayleigh scattering model according to examples of the present disclosure where the inset shows AoP mapping after removing data corresponding to overexposure and high DoCP, and FIG. 2E shows azimuth angle and FIG. 2F shows zenith angle error for different DoCP limits used to remove data from AoP mapping according to examples of the present disclosure.

Underwater polarization measurements were conducted inside a swimming pool at ASU. The swimming pool water was clean, and the measurement was done in a clear sky condition. FIG. 1A shows the underwater polarization imaging system inside clean swimming pool water. FIG. 1B shows the obtained AoP mapping of the partially polarized light inside water. It can be seen that some part of the data is overexposed due to directly taking an image of high-intensity sunlight (red circular portion). This can be removed by considering the overexpose intensity of each polarization grating on the camera image sensor.

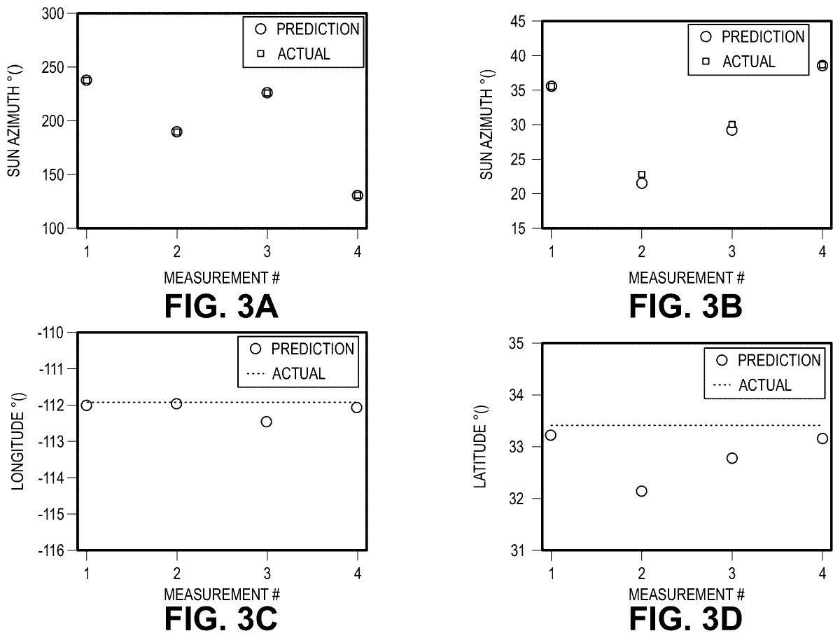

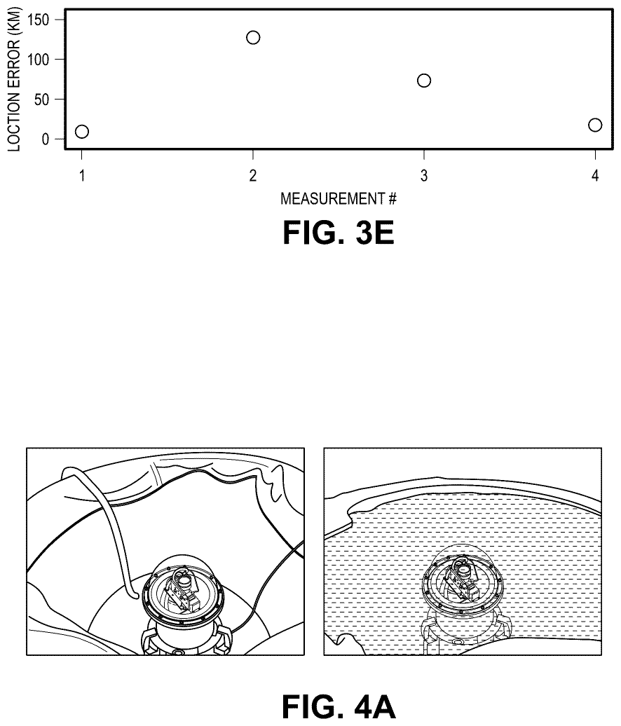

As the sky was clear and the water was clean, not much of DoCP could be seen inside the swimming pool water. But FIG. 3C, the measured DoCP inside swimming pool water, shows that there is a significant amount of DoCP detected. This DoCP represents noise which could arise from light scattering from the surrounding objects near the swimming pool, the edge of the swimming pool, and buildings near the swimming pool. So, the data corresponding to large DoCP can be removed to remove some of the noise seen in the AoP mapping in FIG. 3B. A representative fitting result is shown in FIG. 3D after removing the overexposed data, and some of the data corresponding to high DoCP. The inset of FIG. 3D shows the corresponding AoP mapping after the data removal. AoP mapping after removing data with different DoCP limits is shown and described below. A summary of the fitting errors obtained with this method is presented in FIG. 3E and FIG. 3F, corresponding to the azimuth angle fitting error and Zenith angle fitting error, respectively. When all data points corresponding to DoCP larger than 0.45 are removed, the error is high for both azimuth and zenith angles as not enough noise was removed from the data to have good fitting. Consequently, when all data corresponding to DoCP larger than 0.15 to 0.4 is removed, the azimuth angle error is ˜0.3° and zenith angle error is close to zero. This is because a significant amount of noisy data is removed, and very good fitting with the model is achieved. Furthermore, if all data points having larger DoCP than 0.1 are removed, the fitting error becomes high for both azimuth and zenith angle too much data is removed to have a good fitting. So, a balance is desired between the amount of data that can removed and the fitting error. Limitations: This method requires knowledge about the contents of the water body to decide a suitable DOCP threshold.

Using this method, multiple datasets are processed from different measurements conducted in ASU swimming pool at the same location. From the measured AoP in the swimming pool water, the sun position is extracted by fitting with the skylight transmission model after DoCP thresholding the data similar to the aforementioned process (FIG. 3A and FIG. 3B).

FIG. 3A, FIG. 3B, FIG. 3C, FIG. 3D, FIG. 3E show multiple measurements in ASU swimming pool (33.415222, −111.931604) according to examples of the present disclosure, wherein FIG. 3A and FIG. 3B show predicted sun azimuth and zenith angles obtained by fitting the measured data with the present model after removing noise corresponding to DoCP, FIG. 3C and FIG. 3D show predicted longitude and latitude, determined from the extracted sun positions in FIG. 3A and FIG. 3B, and FIG. 3E shows location prediction error (Km) in terms of absolute distance from the actual measurement location.

From the extracted sun positions, the location is determined as the geolocation and sun position is connected together by the global coordinate system as described below. FIG. 3C and FIG. 3D show the actual location (longitude and latitude) of the measurement and the corresponding prediction of the location obtained from the sun position and the measurement date and time. The absolute location prediction error in Km is shown in FIG. 3E. The minimum location prediction error is ˜23 Km, compared with state of the art this is one of the best location predictions reported in literature. This can be because of the DoCP measurement capability of the present system and noise filtering using DoCP threshold.

### Underwater Navigation and Geolocation in Turbid Water

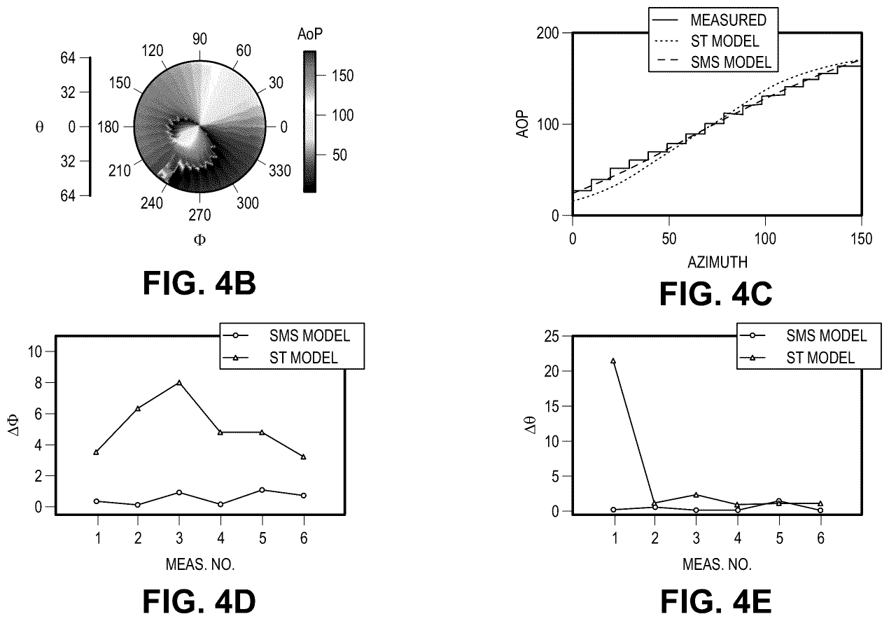

FIG. 4A, FIG. 4B, FIG. 4C, FIG. 4D, and FIG. 4E show underwater Measurement in Tempe Town Lake Water according to examples of the present disclosure, where FIG. 4A shows a measurement setup, FIG. 4B shows measured AoP on Oct. 11, 2021, FIG. 4C shows fitting it with ST (Skylight Transmission) and SMS (Single and Multiple Scattering) Model at Zenith Angle 44°, FIG. 4D shows fitting error in azimuth angle of the sun position, FIG. 4E shows a fitting error in finding Zenith Angle of the sun. Both ST and SMS simulation models are Considered here to compare their fitting accuracy.

Underwater polarization measurements were performed in Tempe town lake water. To do this, a large water tank is used, and the present imaging setup is positioned inside the tank and then pump water from the lake to fill it up. After doing the measurement, the water is pumped out from the tank. A detailed image of the setup is shown in FIG. 4A. With this setup, 0° to 70° zenith angle and 0° to 360° azimuth angle can be covered. The whole hemisphere is visible from within the present polarization measurement setup underwater, through the Snell's window. FIG. 4B shows the measured AoP seen from under the lake water with the present polarization measurement setup. The measurement was done at 10″ depth underwater on Oct. 11, 2021 (33.432262, −111.947299) under a clear sky. From FIG. 4C unlike the AoP measured from the swimming pool water, this AoP from the lake water could not be fitted well with the simple ST (Skylight Transmission) model that was considered before.

This happens because the lake water has more scatters than in swimming pool water. So, a more detailed model can be used that can describe the polarization of light inside turbid water body more accurately than the simple ST model. The model is called SMS or single and multiple scattering model. As the name suggests, the transmitted skylight (single Rayleigh scattering in air) is not only considered, but also, multiple scattering events are considered that can lead to significantly different polarization of the light inside turbid water body. This model comprises three different parts. First is the underwater scattering probability calculation from the water turbidity (PSD and particle density). Second, tracking the light polarization changes for multiple scattering of sunlight (and skylight) inside water. Furthermore, third, combining the effect of light polarization change due to multiple scattering of sunlight (and skylight) inside water and skylight refraction inside water considering different ratios and probability of each event. Underwater light scattering is a random process that depends on the sun's position, refractive index ratio of scatterer and water, scatterer's size, scatterer concentration, and water depth. This real-world random can be emulated as the flowchart is presented as described further below.

The light polarization states are calculated using Muller matrices related to each event, and the calculation for each of these events are done separately, as described further below. These processes contribute to forming the light polarization distribution that can be seen underwater. So, in the end, they are all added up after weighting them with different ratios or probability corresponding to each of these events, as shown below,

$$S = {R}_{sun} {P}_{sun \_ scat} {S}_{sun \_ scat} + {R}_{sky} ( {S}_{sky \_ scat} {P}_{sky \_ scat} + {S}_{sky \_ refract} ( 1 - {P}_{sky \_ scat} ) ) \qquad ( 1 )$$

Here, S=Final Stokes parameter of light; Rₛᵤₙ=Sunlight ratio; R_{sky}=Skylight ratio; S_{sun_scat}=Stokes parameter after sunlight scattering inside water; S_{skyz_scat}=Stokes parameter after Skylight scattering inside water; S_{sky_refract}=Skylight refracting inside water; P_{sky_scat}=Skylight scattering probability inside water; P_{sun_scat}=sunlight scattering probability inside water.

P_{sun_scat} and P_{sky_scat} are calculated using the Monte Carlo simulation. This simulation considers the particle size distribution (PSD) and particle density (m⁻³), representing water turbidity. PSD is obtained from Dynamic Light Scattering (DLS) measurement. DLS measurement does not provide the particle number density. But the particle density (m⁻³) from PSD can be calculated, Beer-Lambert Law, and Mie scattering theory as explained in the previous sections, and further described below. In addition, a detailed calculation method of SMS mathematical model is described further below.

From FIG. 4C, the new model (SMS model) fits better with the measured AOP from Lake water. Measurements were performed and provided the fitting results for both ST and SMS models for comparison in FIG. 4D and FIG. 4E. As the error in the sun position is very small (<0.5° for both Azimuth and Zenith angles), and ˜100 km absolute location error detection can be achieved with the fitted sun positions shown here.

In this disclosure, an underwater polarization mapping system is described to map the polarization state of light underwater and use it for navigation. A dual camera system is used for full stokes parameter detection in underwater environments. Full stokes parameters are used to analyze the measured polarization information more intensively than only detecting linearly polarized light in most of the reported works in literature. Also, an automatically controlled robotic arm is used to map the whole sky with two small field of view (FOV ˜10°) cameras because it reduces the requirement of high dynamic range of the exposer time needed for ever changing intensity of light in different directions. Also, small FOV lenses introduce smaller polarization distortions (due to small incident angle of light on the CMOS sensor) in the measurement as described in the main text. Furthermore, automatic control of the imaging system increases the accuracy, repeatability and ease of use of the present system. Data analysis methods are described that have proved to be very efficient in removing nose from the measured data. In this disclosure, a mathematical model is described that can describe the light polarization in turbid water where there are a lot more scatters than in clear water. This model can be used to fit the measured underwater light polarization data and back calculate the sun position to determine the geolocation of the measurement more accurately than the simple skylight transmission model. Overall, with the present underwater light polarization measurement system and mathematical model, navigation and geolocation determination are provided in clear swimming pool water with accuracy within 23 Km and for turbid water around 100 Km location determination error.

### Materials and Methods

### Method:

### Fitting Process:

DoLP, DoCP, and AoP are taken from the measurement to initiate the fitting. As is known, in the present measurement, there should not be a very large DoCP. Any interference from the environment, such as buildings, trees, birds or airplanes, and other things that unintentionally comes into the present measurement. Those can introduce erroneous pixels or large DoCP values. So, some parts of the data can be removed based on DoCP, which will only decrease the accuracy. Then, the measured DoLP is used to fit the analytical DoLP equation to approximately determine the azimuth(ϕₑₛₜ) and zenith(θₑₛₜ) of the sun. Then, the search for a more accurate sun position with the processed data begins.

Different sun positions are checked within a defined range around the initially estimated sun position. To check if the sun position that is guessed is the real sun position or not, the standard deviation (or MSE) is calculated between the measured AoP and the simulated AoP for each guessed sun position. Then compare which guessed sun position provides the smallest standard deviation from measurement. That is the new guess for the next iteration of sun position search with a reduced search range. This process can go on 5 or 6 times. Then, among these guesses for each iteration, the sun position can be determined that provides the smallest standard deviation. That is the fitted sun position.

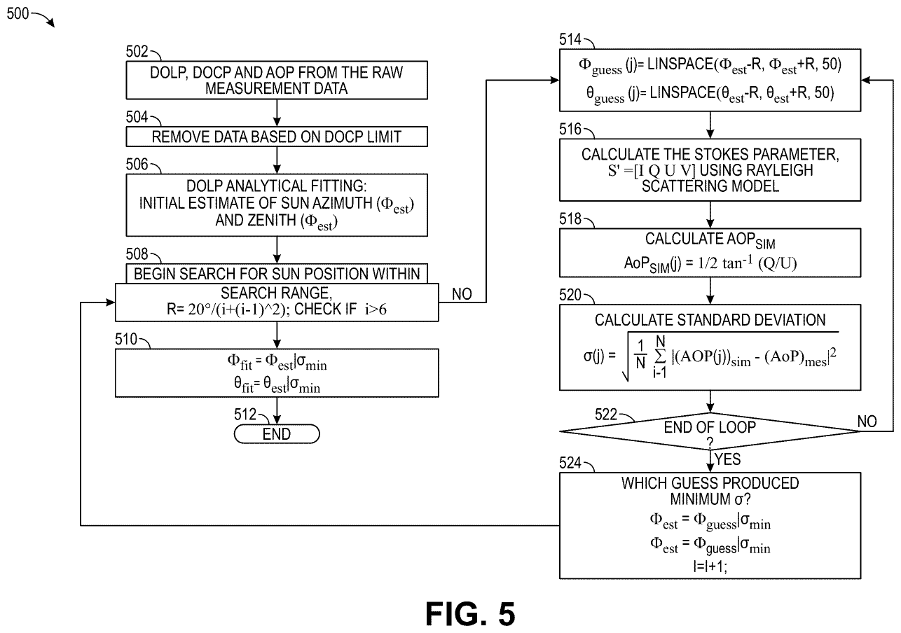

FIG. 5 shows a flowchart 500 for a method according to examples of the present disclosure. The method can begin by obtaining DoLP, DoCP, and AoP from the raw measurement data, at 502. The method continues by removing data based on DoCP limit, at 504. The method continues by performing a DoLP analytical fitting using an initial estimate of sun azimuth(ϕₑₛₜ) and zenith (Θₑₛₜ), at 506. The method continues by beginning a search for the sun position within a search range, R=20°/(i+(i−1)\hat{ }2) and a check is performed if i>6, at 508. If the results from 508 is positive, the method determines that Φ_{ƒit}=(Φₑₛₜ|σₘᵢₙ) and Θ_{ƒit}=(Θₑₛₜ|σₘᵢₙ) at 510 and the method can end at 5102. If the results from 508 are negative, the method continues by calculating the parameters Φ_{guess}(j)=linspace (Φₑₛₜ−R, Φₑₛₜ+R, 50) and Θ_{guess}(j)=linspace (Θₑₛₜ−R, Θₑₛₜ+R, 50), at 514. The method continues by calculating the stokes parameter, S′=[I Q U V] using the Rayleigh scattering model, at 516. The method continues by calculating AoPₛᵢₘ, where

$${AoP}_{sim} ( j ) = \frac{1}{2} {tan}^{- 1} ( \frac{Q}{U} ) ,$$

at 518. The method continues by calculating the standard deviation σ(j), where

$$σ ( j ) = \sqrt{\frac{1}{N} {\sum }_{i = 1}^{N} {\vert {( AoP ( j ) )}_{sim} - {( AoP )}_{mess} \vert}^{2}} ,$$

at 520. The method continues by making a determination to end the loop or not to end the loop, at 522. If the determination at 522 is not to end the loop, the method goes back to 514. If the determination at 522 is to end the loop, the method continues by determining which guess produced a minimum σ, where Φₑₛₜ=(Φ_{guess}|σₘᵢₙ), Θₑₛₜ=(Θ_{guess}|σₘᵢₙ), and i−=i+1, at 524 and then proceeds back to 508.

### Correction for Off-Center Camera:

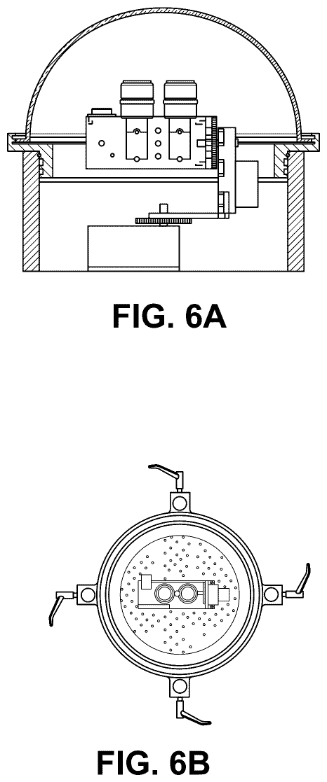

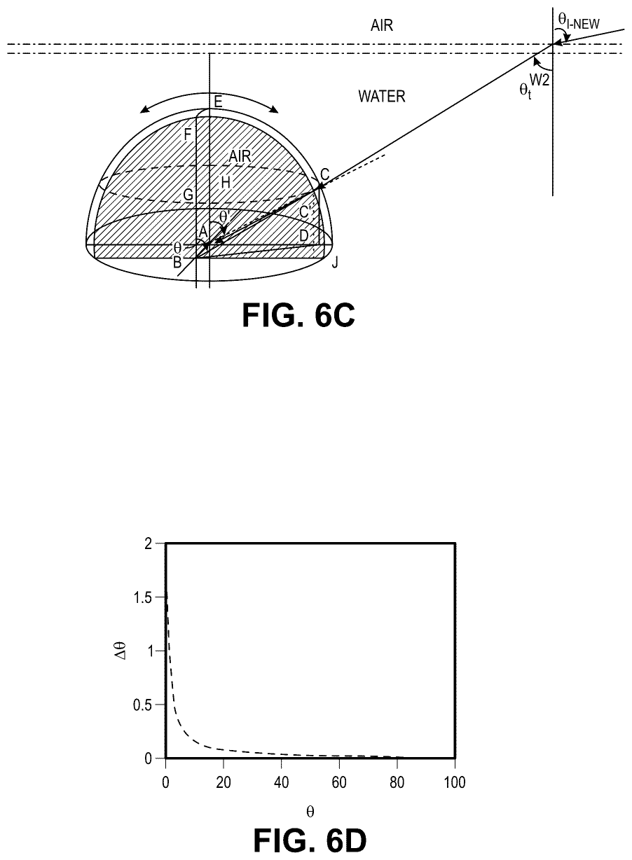

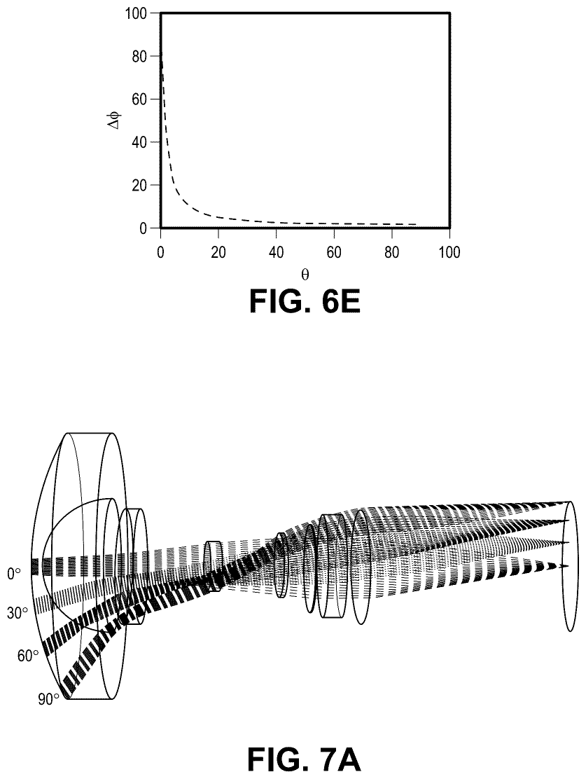

The present underwater polarization imaging system comprises one LP camera 120 and one CP camera 118. The LP camera 120 captures the polarization information for linearly polarized light, and the CP camera 118 captures the polarization information of the CP light. So, when underwater, as the camera is not in the center of the dome (FIG. 6A and FIG. 6B), it each receives light from a slightly different azimuth and zenith angle compared to the recorded azimuth and zenith angle for each image taken with the camera. This can be corrected by considering angle shift for off-centered incident light (FIG. 6C) and conducting some geometric operations. Considering the refractive index changes from air to water, the off-center correction for zenith and azimuth angle (FIG. 6D and FIG. 6E) can be calculated. In FIG. 6D and FIG. 6E, it can be seen that the Δθ and Δφ, zenith and azimuth angle correction for the LP camera. So, after completing the fitting analysis with the data, these corrections can be added to the recorded zenith and azimuth angle to find the sun position. The detailed calculation process is described further below.

When the light gets into the water, the light is refracted, and the direction of light changes. The same thing happens when the light goes into the dome (containing the camera) from water. The light direction changes according to Snell's law,

$${n}_{air} * Sin ( {θ}_{t}^{D} ) = {n}_{water} * Sin ( {θ}_{i}^{D} )$$

### Zenith Angle Correction:

After some simple geometric treatment, the error (Δθ) introduced in the zenith angle due to the off-center camera can be shown as,

$${θ}^{new} = acos ( cos ( θ ) / sqrt ( {( tan ( {θ}_{t}^{D} - {θ}_{i}^{D} ) )}^{2} + {( sin ( θ ) )}^{2} + {( cos ( θ ) )}^{2} ) )$$

$$Δθ = {θ}^{new} - θ$$

### Azimuth Angle Correction:

Using simple geometric treatments, the error introduced in azimuthal angle (Δφ) can be shown as,

$$Δφ = asind ( ( tan ( {θ}_{t}^{D} - {θ}_{i}^{D} ) ) / sqrt ( {( tan ( {θ}_{t}^{D} - {θ}_{i}^{D} ) )}^{2} + {( sin ( θ ) )}^{2} ) )$$

### Determining Magnetometer Error:

The magnetometer is a critical part of the present measurement. It provides the azimuthal angle of the camera pointing direction with respect to some preset reference (here, the sun is taken as reference). Unfortunately, sometimes when the magnetometer data is read from the sensor, it provides erroneous data and also deviates from the actual azimuthal angle after a continuous operation with the sensor for a long time. Moreover, because an off-center camera is used, this error manifests as a combination of magnetometer deviation and off-center camera error mentioned above. To calculate the magnetometer error correctly, the steps mentioned below can be used:
1. Read and record the sun azimuth angle from the magnetometer when pointing toward the sun. Also, record the zenith angle of the sun. Also, a record which camera (LP or CP) is used for this step.
2, Record the time of doing step 1.
3. Calculate the sun azimuth angle using the time recorded in step 2 for the measurement location.
4. Subtract the sun azimuth angle calculated in step 3 from step 2. This difference is a mixture of magnetometer deviation and off-center camera error.
5. Calculate the off-center camera error for the zenith angle recorded in step 1. Then subtract (add) the error if using CP camera (LP camera) in step 1.

### Calculation of DoCP:

Two different cameras are used to measure the LP and CP polarization information of light. These two cameras are called LP and CP cameras. To calculate the Degree of Circular Polarization or DoCP, the LP intensity and CP intensity measured by these two cameras are used. One point to notice is that the distance of these two cameras from the center is also not the same. Lp camera is 0.83″, and the CP camera is 1.33″ from the center. So, the off-center error introduced for these two cameras is also different. To compensate for this, the steps below are used to calculate the DoCP,
1. Read LP and CP intensities from LP and CP camera. Even though these two components have the same recorded azimuth and zenith angle (as one gyroscope is used), they have different off-center errors mixed with them.
2. Calculate the off-center error for both of these cameras.
3. Make corrections to the off-center error for both LP and CP intensities. Now, these two components have different azimuth and zenith angles.
4. Now, find CP and LP intensities at the same azimuth and zenith angles of the LP camera.
5. Calculate DoCP using the following equation, DoCP=2*CP intensity/0.9−LP intensity. The CP intensity is divided by 0.9 to compensate for the reduced intensity due to the CP filter used with the CP camera.
6. Then add the LP camera off-center error to the DoCP data to reverse back the correction.
7. Then find DoCP at the same azimuth angles recorded with the LP camera in step 1.

### Polarization Aberration of Lens With Different AFOV

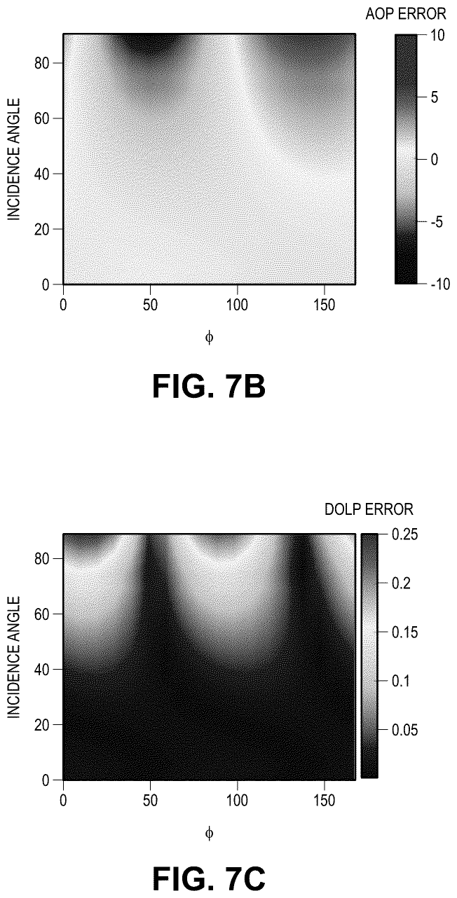

FIG. 7A, FIG. 7B, and FIG. 7C shows a simulation of polarization aberration introduced using polarization ray tracing, according to examples of the present disclosure, where FIG. 7A shows a ray diagram of a fisheye lens, FIG. 7B shows an AOP error that is introduced by the fisheye lens (AFOV=180°) at the focal plane as a function of incidence angle and AOP of linearly polarized incident light, and FIG. 7C shows a DOLP error introduced by a fisheye lens) (AFOV=180° at the focal plane as a function of incidence angle and AOP of linearly polarized incident light.

Previous works on sky polarization mapping systems generally use large AFOV lenses, such as the fisheye lens, for polarization mapping (https://protect.checkpoint.com/v2/r01/______https://sites.google.com/site/danreiley/PhotoPrime).______.YzJ1Om1oMnRlY2hub2xvZ3lsYXdncm91cDpjOm86MTMwMGNhMjllNzI0YTFmNThjNzRjMDQ2MWViYTJhZDc6NzpmNjQ1OjBmYmEyNDUyYTA1MDgyNTcyOWVlOWU5MjthMjQ0OWUzZDQ3N2UxNzcyMjQ5NjA5YmEzZTA4N2Q3YjFlNzBkMDg6dDpUOkY). However, the polarization aberration introduced by fisheye lenses is often ignored. FIG. 7A, FIG. 7B, and FIG. 7C show the 3D ray diagram of a fisheye lens (U.S. Pat. No. 7,161,746-1, downloaded from lens library website) with an AFOV of 180°. The effective focal length and the f-number of the fisheye lens are 10 mm and 2.9 for this fisheye lens. The Mueller matrix of the fisheye lens is calculated using the built-in polarization ray tracing function in Zemax. Then, polarization aberration is estimated using linearly polarized light (LPL) as input with changing polarization axis angle ϕ to assimilate skylight polarization. Details about the simulation settings and calculation of polarization aberration are included herein. FIG. 7B shows the AOP error mapping as a function of ray incidence angle θ and AOP of incident LPL. AOP error is defined as:

$${Δ}_{AOP} = Calculated AOP - Reference AOP \qquad ( 1.1 )$$

Overall, AOP error increases as the incidence angle increases. Specifically, AOP is less than 1° for θ<40° and increases quickly to ˜8° at θ=90°. FIG. 7C shows the DOLP error as a function of θ and ϕ; DOLP error is defined as:

$${Δ}_{DOLP} = Calculated DOLP - Reference DOLP \qquad ( 1.2 )$$

For the fisheye lens, DOLP error at the focal plane is less than 5% at θ<40° and increases to 25% at θ=90°. Such high polarization aberration fundamentally limits polarization navigation accuracy.

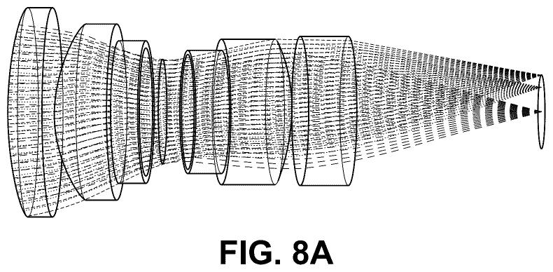

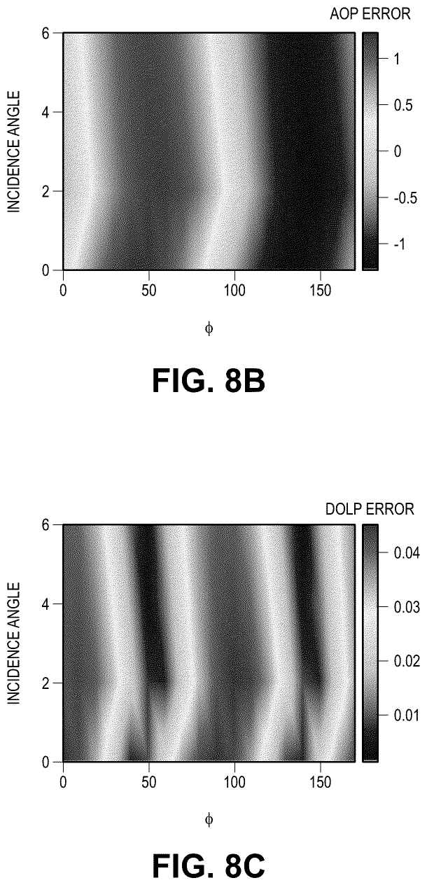

FIG. 8A, FIG. 8B, and FIG. 8C show a simulation of polarization aberration introduced using polarization ray tracing, according to examples of the present disclosure, where FIG. 8A shows a ray diagram of a small AFOV=12° lens, FIG. 8B shows an AOP error introduced at focal plane as a function of incidence angle and AOP of linearly polarized incident light, and FIG. 8C shows a DOLP error introduced at focal plane as a function of incidence angle and AOP of linearly polarized incident light.

FIG. 8A, FIG. 8B, and FIG. 8C show the 3D ray diagram of an AFOV=12° lens (U.S. Pat. No. 2,601,805-1 downloaded from lens library website). The effective focal length and the f-number of the fisheye lens are 25 mm and 4.3 for AFOV=12° lens, respectively. The AOP error and DOLP of it are shown in FIG. 8B and FIG. 8C, respectively. AOP error is less than 1° while the DOLP error is less than 5% over the whole incidence angle and LP azimuth angles. Compared to the fisheye lens, the AFOV=12° has a much smaller AOP error range. Thus, it is favored for high-accuracy polarization mapping of the sky. Besides, a small object is often needed to manually block the sun in the imaging scene when using the fisheye lens to avoid overexposure issues (H. Zhao, W. Xu, Y. Zhang, X. Li, H. Zhang, J. Xuan, B. Jia, Polarization patterns under different sky conditions and a navigation method based on the symmetry of the AOP map of skylight. Opt. Express. 26, 28589 (2018).) due to strong brightness along the sun's direct incidence direction. The object location must be adjusted according to the sun's location, which makes fully automatic polarization mapping difficult. This issue can also be addressed by using a narrow AFOV lens, as now the mapping can be done through spatial scanning mode. During the scanning, the exposure close to the sun can be adjusted accordingly to minimize the impact of the sun's direct incidence on polarization mapping.

### Polarization Detection Accuracy Evaluation of IMX MZR 250 at Different Oblique Incidence Angle

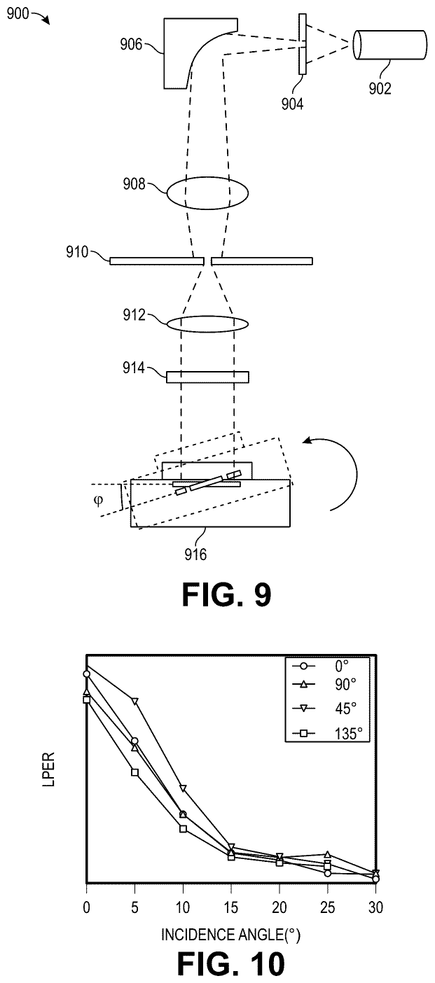

FIG. 9 shows a schematic of a system 900 for measuring linear polarization extinction ratio (LPER) of Sony IMX MZR250 under oblique incidence, according to examples of the present disclosure. The system 900 comprises a halogen lamp fiber 902 that provides light that is directed through a first iris 904 and onto a reflecting element 906. First reflecting element 906 reflects the light through first refracting element 908, through a second iris 910, through a second refracting element 912, and through a polarizer 914 and onto a sensor 916. The sensor 916 can be a Sony IMX250MZR/MYR CMOS polarized sensors where the sensors have on-chip four different directional polarizing filters (0°, 90°, 45°, and 135°) on every four pixels.

FIG. 10 shows a plot of LPER of Sony IMX 250MZR as a function of incidence angle according to examples of the present disclosure.

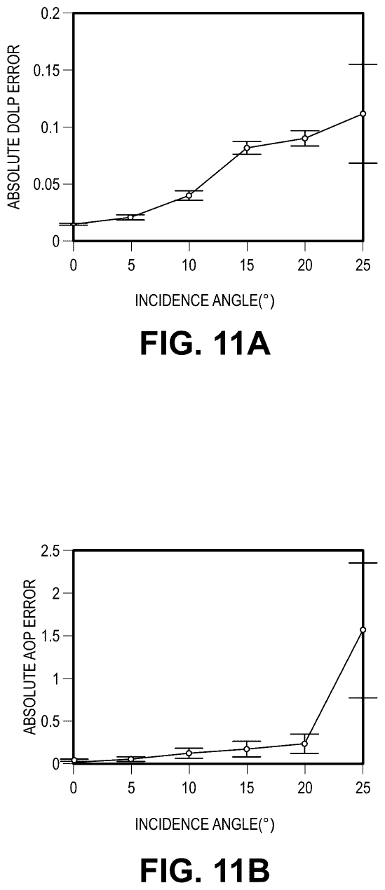

FIG. 11A and FIG. 11B show a theoretical estimated polarization detection error due to limited LPER according to examples of the present disclosure, where FIG. 11A shows a plot of estimated Degree of linear polarization (DOLP) detection error vs. incidence angle and FIG. 11B shows a plot of angle of polarization (AoP) detection error vs. incidence angle.

### Skylight Polarization Mapping:

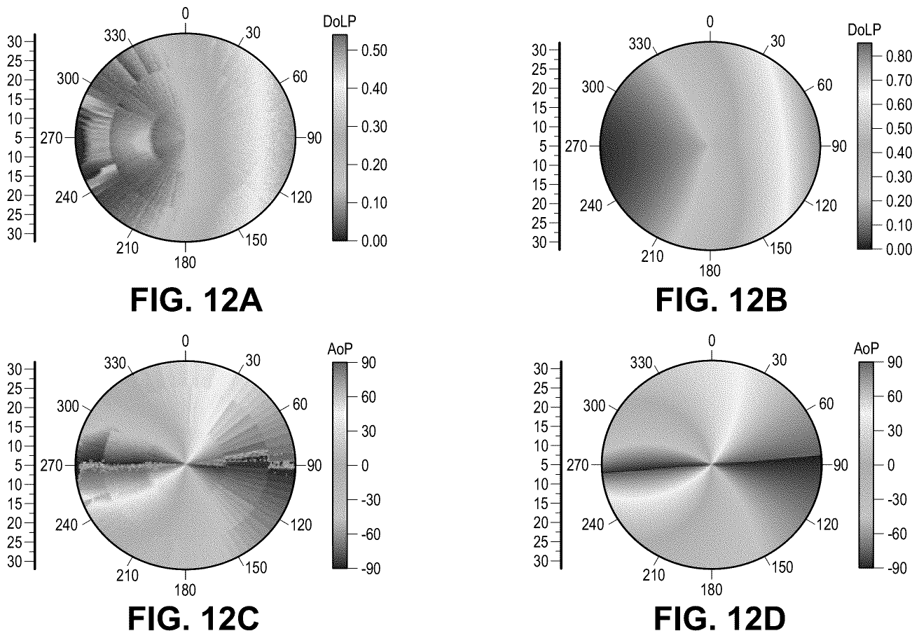

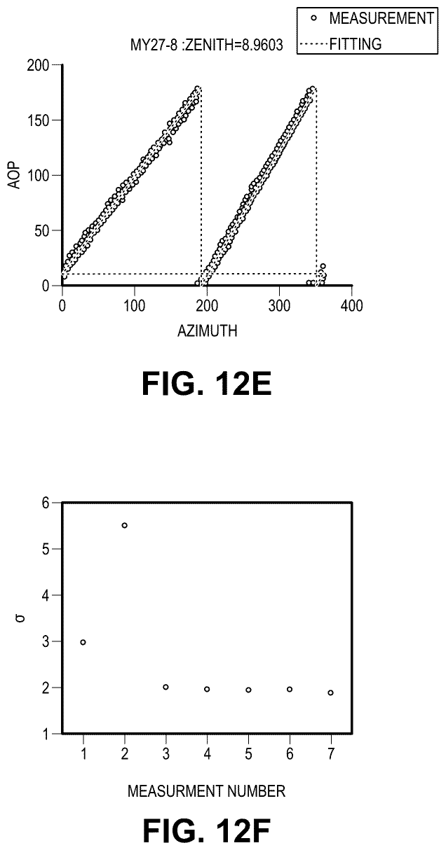

FIG. 12A, FIG. 12B, FIG. 12C, FIG. 12D, FIG. 12E, and FIG. 12F show schematic of auto polarization mapping; Automatic polarization mapping measurement and simulation in the air according to examples of the present disclosure, where FIG. 12A and FIG. 12B shows measured Angle of polarization (AOP) and Degree of linear polarization (DOLP), respectively, FIG. 12C and FIG. 12D shows simulated AOP and DOLP of the sky at the same time and location, respectively, FIG. 12E shows a plot of linear fitting to calculate solar meridian, and FIG. 12F shows a plot of RMS value of solar meridian calculation of seven measurement.

The sky polarization state is measured under sunny, cloudless, or few cloud conditions to verify the system's polarization navigation accuracy. All the measurements were collected in the air at Arizona State University, in which latitude and longitude are 33.4204362°, −111.9310406° respectively. The measured degree of linear polarization (DOLP) and angle of polarization (AOP) patterns are shown in FIG. 12B and FIG. 12C, respectively, as measured in the entire visible spectrum range. The polarization patterns of a clear Rayleigh sky are calculated simultaneously and at the exact location, as shown in FIG. 12D and FIG. 12E. Apart from the regions near the solar position, the comparison of the simulated result and the measured result shows a relatively good agreement: (i). The DOLP pattern shows a minimum at sun location (azimuth 270°), then gradually increases and reaches a maximum at azimuth 90°, opposed to the sun. (ii). an evident symmetrical distribution of AOP values can be found along the solar meridian line in azimuth.

The most obvious difference comes from two parts: (i) the uneven and abrupt change of AOP measurement around the sun's position due to overexposure of the sun's direct incidence, even at the minimum exposure time the camera can give. (ii) Fringes are often seen in the measured AOP and DOLP pattern, which is mainly due to in-perfect image stitching.

To verify the system's detection accuracy, the least mean square fitting method is used to fit the original mapping data with the Rayleigh scattering model to find the value solar meridian, as shown in FIG. 2F. A line scanning of 360° sky mapping in azimuth and zenith 8.96° data is used to find solar meridian in order to reduce the calculation time. The fitted result shows good consistency with the original data, which gives an AOP solar meridian determination error of ˜1.3°. Obviously, in one full-sky mapping, abundant 360° azimuth line scan data and be applied for fitting. To further verify the fitting method's stability, seven tests were conducted at the exact location at a different time. In each round of mapping, line scan data at all zenith angles are separately fitted to find the solar meridian. FIG. 2F shows the root mean square (RMS) value of all fitted results in seven individual measurements. ˜70% of the fitted work shows RMS<2, which indicates the fitting method is stable.

### Fitting Process:

The DoLP, DoCP, and AoP are taken from the measurement to initiate the fitting. As is know, in the present measurement, there should not be a very large DoCP. Any interference from the environment, such as buildings, trees, birds or airplanes, and other things that unintentionally comes into the present measurement. Those can introduce erroneous pixels or large DoCP values. So, some parts of the data can be removed based on DoCP, which will only decrease the accuracy. Then, the measured DoLP can be used to fit the analytical DoLP equation to approximately determine the azimuth (ϕₑₛₜ) and zenith (θₑₛₜ) of the sun. Then, the search for a more accurate sun position with the processed data is performed.

Different sun positions within a defined range around the initially estimated sun position are checked. To check if the sun position that was guessed is the real sun position or not, the standard deviation (or MSE) between the measured AoP and the simulated AoP for each guessed sun position is calculated. Then compare which guessed sun position provides the smallest standard deviation from measurement. That is the new guess for the next iteration of sun position search with a reduced search range. This process can go on 5 or 6 times. Then among these guesses for each iteration, the sun position is determined that provides the smallest standard deviation. That is the fitted sun position.

### Geolocation Determination:

After the sun's position has been determined, the location of the earth that this sun's position corresponds to can be determined. To do this, the measurement date, time, time zone (GMT), and the extracted sun position from the previous section are used.

The sun's position is related to the location on earth through the following equations (derived from spherical geometry in) (https://protect.checkpoint.com/v2/r01/______http://powerfromthesun.net/Book/chapter03/chapter03.html).______.YzJ1Om1oMnRlY2hub2xvZ3lsYXdncm91cDpjOm86MTMwMGNhMjllNzI0YTFmNThjNzRjMDQ2MWViYTJhZDc6NzpjNDIyOmVhMjVmODFkMjQ1YTFhODE1Zjk5MzZlMTViOTkxNzk0ZjJhMTUwOWE3YmU3ZjQyM2JlNWYwZmNmNDk0ODZhOGI6dDpUOkY),

$$cos ( θ ) = cos ( lat ) cos ( ω ) cos ( δ ) + sin ( lat ) sin ( δ ) \qquad ( 2 )$$

$$cos ( ϕ ) = \frac{cos ( δ ) sin ( lat ) cos ( ω ) - sin ( δ ) cos ( lat )}{cos ( 90 - θ )} \qquad ( 3 )$$

Here, lat is the latitude and lon is the longitude of the location on earth, ω is the hour angle, δ is the declination angle, θ is the zenith angle of the sun, and ϕ is the azimuth angle of the sun. The hour angle ω is derived from local solar time or LST, which represents the actual solar time at that position. The equations for o and LST are provided below (3-5),

$$ω = 12 ( L S T - 12 ) \qquad ( 4 )$$

$$L S T = L T - \frac{1}{15} ( L S M - Lon ) + E O T - D L S \qquad ( 5 )$$

LST or Local solar time is derived from the local time (LT), the difference between the actual longitude (Lon) and the standard meridian for the local time zone (LSM), Equation of Time (EOT), and correction for daylight saving or DLS.

The equation for LSM is provided below (3-5),

$$L S M = 15 * G M T \qquad ( 6 )$$

LSM is obtained from Greenwich Mean Time or GMT. GMT is the difference between your time and the time in the prime meridian. Whether you are east or west of the prime meridian, GMT will be either positive or negative. Equation of time is provided below (3-5),

$$E O T = 0.1 \; 65 sin ( 2 B ) - 0.1 \; 26 cos ( B ) - 0.0 \; 25 sin ( B ) \qquad ( 7 )$$

$$B = \frac{360}{365} ( n - 81 ) \qquad ( 8 )$$

The equation of time depends on the number of day (derived from the date of measurement) of the year or n.

The equation of declination angle is provided below (3-5),

$$δ = 2 3.45 si n ( \frac{360}{365} ( 284 + n ) ) \qquad ( 9 )$$

The declination angle, δ, also depends on the number of the day or n and it's not dependent on the observer's position on earth.

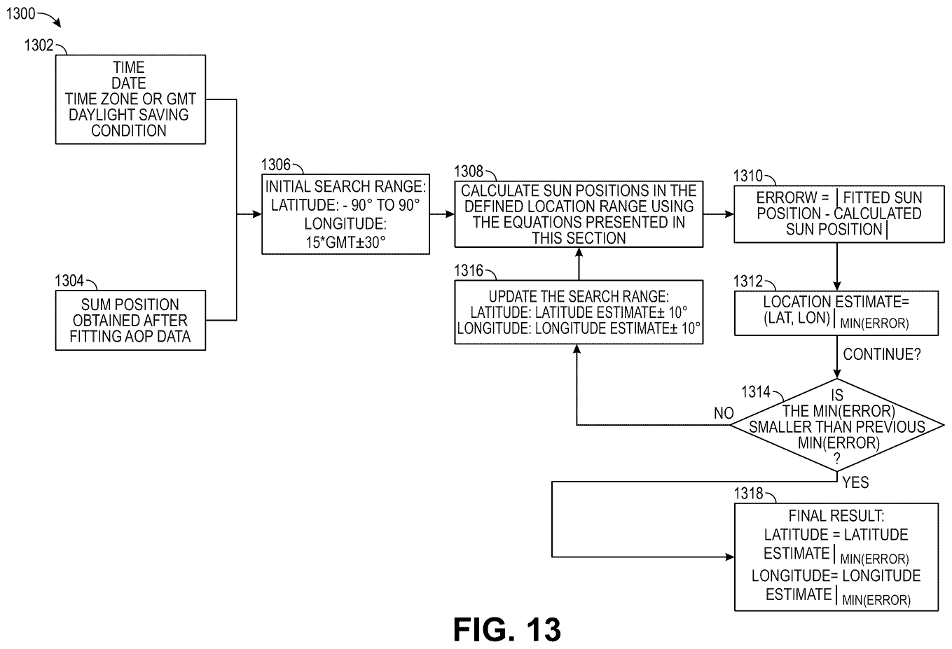

Now, if the sun's position, date, time, and time zone of the measurement are known, then everything except the location or the latitude and longitude of the earth is known. So, the extracted sun position and these equations can be used to calculate the latitude and longitude of the measurement location numerically. A brief description of the location determination process is presented in the flow chart in FIG. 13.

FIG. 13 shows a flow chart 1300 describing the process of location determination from a fitted sun position according to examples of the present disclosure. The process begins by obtaining the time, date, time zone or GMT, and daylight savings condition at 1302 and obtaining the sun position after fitting AoP data at 1304. The process continues by initiating an initial search range with the latitude between −90° and +90° and the longitude between 15*GMT±30°, at 1306. The process continues by calculating the sun positions in the defined location range using the equations discussed herein, at 1308. The process continues by determining the error of the position of the sun by using Error=|Fitted Sun position−Calculated sun position|, at 1310. The process continues by determining the location estimate for the sun by using Location Estimate=(Lat, Lon)|ₘᵢₙ₍ₑᵣᵣₒᵣ₎, at 1312. The process continues by determining if the minimum error is smaller than the previously determined minimum error, at 1314. If the minimum error is not smaller than the previously determined minimum error determined at 1314, then the process continues by updating the search range where the latitude is updated by adjusting the latitude estimate by ±10° and the longitude is updated by adjusting the longitude estimate by ±10°, at 1316 and then proceeding back to 1308. If the minimum error is smaller than the previously determined minimum error determined at 1314, then the process ends at 1318 outputting a final result of the latitude=Latitude Estimate|ₘᵢₙ₍ₑᵣᵣₒᵣ₎ and the longitude=Longitude Estimate|ₘᵢₙ₍ₑᵣᵣₒᵣ₎.

Correction for off-Center Camera:

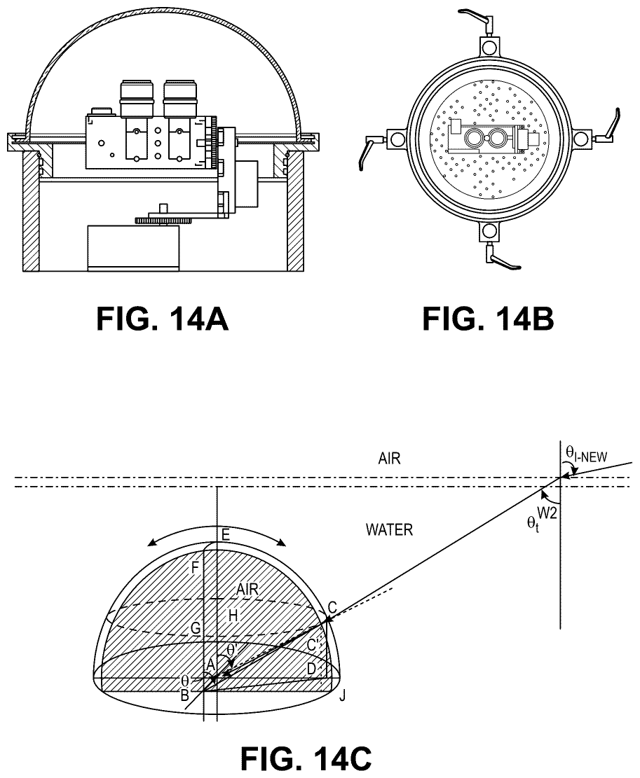

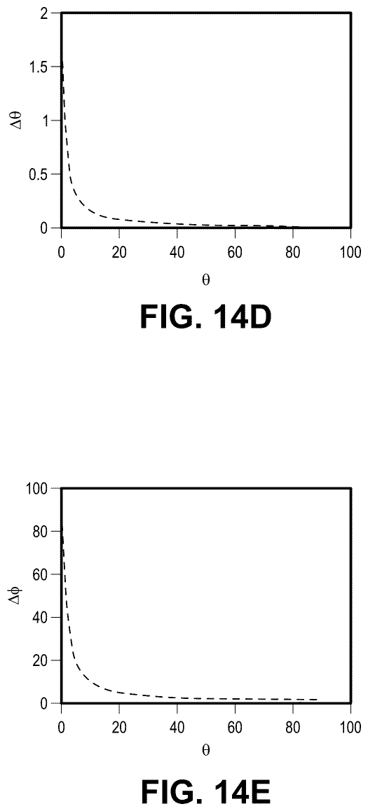

FIG. 14A, FIG. 14B, FIG. 14C, FIG. 14D, and FIG. 14E show a cross-section of our polarization measurement tool and calculation of off-center camera correction for zenith and azimuth angles according to examples of the present disclosure. The present underwater polarization imaging system comprises one LP camera and one CP camera. The LP camera captures the polarization information for linearly polarized light and the CP camera captures the polarization information of the CP light. So, when underwater, as the camera is not in the center of the dome (FIG. 14A and FIG. 14B), it each receives light from a slightly different azimuth and zenith angle compared to the recorded azimuth and zenith angle for each image taken with the camera. This can be corrected by considering the path of light falling on the camera (arrow from C to B in FIG. 14C) and essentially figuring out where it was supposed to fall if it was not off-centered (arrow from C to A (center) in FIG. 14C). Moreover, by conducting some geometric operations, considering the refractive index changes from air to water, the off-center correction for zenith and azimuth angle can be calculated (FIG. 14D). FIG. 14D and FIG. 14E show the Δθ and Δφ, zenith and azimuth angle correction for the LP camera, respectively. So, after completing the fitting analysis with the data, these corrections are added to the recorded zenith and azimuth angle to find the sun position. The detailed calculation process is provided further below. When the light gets into the water, the light is refracted, and the direction of light changes. The same thing happens when the light goes into the dome (containing the camera) from water. The light direction changes according to Snell's law,

$${n}_{air} * Sin ( {θ}_{t}^{D} ) = {n}_{water} * Sin ( {θ}_{i}^{D} )$$

### Zenith Angle Correction:

After some simple geometric treatment, the error (Δθ) introduced in the zenith angle due to the off-center camera can be determined as follows,

$${θ}^{new} = acos ( cos ( θ ) / sqrt ( {( tan ( {θ}_{t}^{D} - {θ}_{l}^{D} ) )}^{2} + {( sin ( θ ) )}^{2} + {( cos ( θ ) )}^{2} ) )$$

$$Δθ = {θ}^{new} - θ$$

### Azimuth Angle Correction:

Using simple geometric treatments, the error introduced in azimuthal angle (Δφ) can also be determined as follows,

$$Δφ = a sin d ( ( tan ( {θ}_{t}^{D} - {θ}_{i}^{D} ) ) / sqrt ( {( tan ( {θ}_{t}^{D} - {θ}_{i}^{D} ) )}^{2} + {( sin ( θ ) )}^{2} ) )$$

### Determining Magnetometer Error:

The magnetometer is one part of the present measurement, which provides the azimuthal angle of the camera pointing direction with respect to some preset reference (here, the sun is taken as a reference). Unfortunately, sometimes when the magnetometer data is read from the sensor, it provides erroneous data and also deviates from the actual azimuthal angle after a continuous operation with the sensor for a long time. Moreover, as an off-center camera is used, this error manifests as a combination of magnetometer deviation and off-center camera error mentioned above. To calculate the magnetometer error correctly, the steps mentioned below can be used:
1. Read and record the sun azimuth angle from the magnetometer when pointing toward the sun. Also, record the zenith angle of the sun. Also, a record which camera (LP or CP) is used for this step.
2. Record the time of doing step 1.
3. Calculate the sun azimuth angle using the time recorded in step 2 for the measurement location.
4. Subtract the sun azimuth angle calculated in step 3 from step 2. This difference is a mixture of magnetometer deviation and off-center camera error.
5. Calculate the off-center camera error for the zenith angle recorded in step 1. Then subtract (add) the error if using CP camera (LP camera) in step 1.

### Calculation of DoCP:

Two different cameras are used to measure the LP and CP polarization information of light, which are called a LP camera and a CP camera. To calculate the Degree of Circular Polarization or DoCP, the LP intensity and CP intensity are measured by these two cameras. One point to notice is that the distance of these two cameras from the center is also not the same. Lp camera is 0.83″, and the CP camera is 1.33″ from the center. So, the off-center error introduced for these two cameras is also different. To compensate for this, the steps below are used to calculate the DoCP,
1. Read LP and CP intensities from LP and CP camera. Even though these two components have the same recorded azimuth and zenith angle (as only one gyroscope is used), they have different off-center errors mixed with them.
2. Calculate the off-center error for both of these cameras.
3. Make corrections to the off-center error for both LP and CP intensities. Now, these two components have different azimuth and zenith angles.
4. Now, find CP and LP intensities at the same azimuth and zenith angles of the LP camera.
5. Calculate DoCP using the following equation, DoCP=2*CP intensity/0.9−LP intensity. The CP intensity is divided by 0.9 to compensate for the reduced intensity due to the CP filter used with the CP camera.
6. Then add the LP camera off-center error to the DoCP data to reverse back the correction.
7. Then find DoCP at the same azimuth angles recorded with the LP camera in step 1.

### Particle Density Calculation From Lab Measurement:

During underwater measurements, water from the lake was collected and brought to the laboratory and filled a 27 cm×10 cm water tank. For this measurement, an unpolarized light source (a battery powered torch), a CMOS camera, and the larger side of the tank (27 cm side), was used. First, the intensity of light was measured without the water tank (I₀₁) and with the water tank without water (I_{w1}). Second, the intensity of light was measured with the water tank filled with water (I_{w2}). As a quite unstable light source was used, the light intensity was measured without any water tank (I₀₂) again. The measurement process is illustrated in FIG. 13.

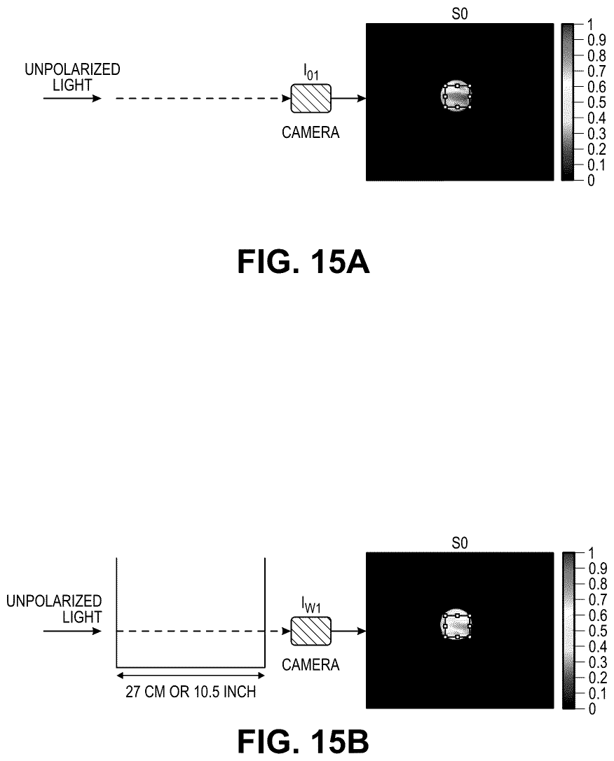

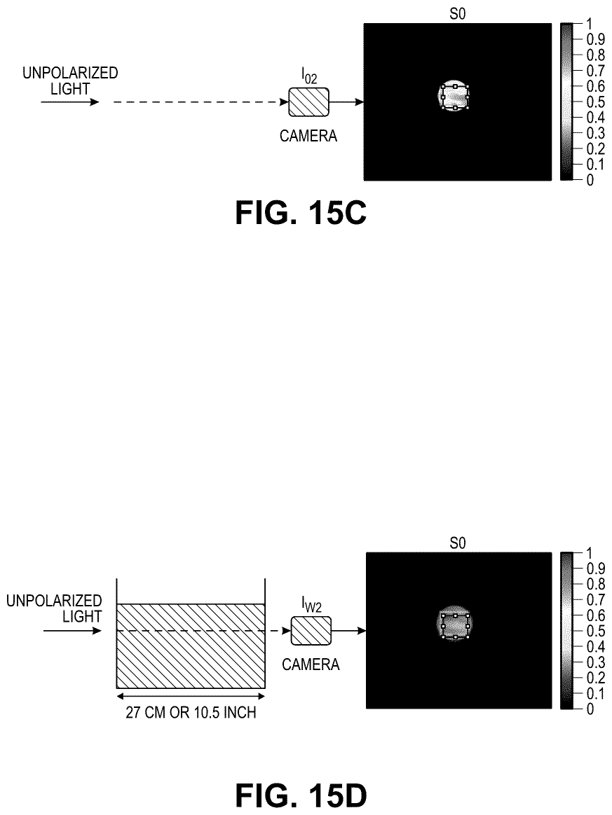

FIG. 15A and FIG. 15B show aspects of a device for capturing the intensity of light without and with the water tank to set a baseline for measurement, according to examples of the present disclosure. FIG. 15C and FIG. 15D show aspects of measuring the intensity of light without and with the water tank full of lake water, according to examples of the present disclosure.

The mean free path (MFP) can be calculated by using the following equation obtained from Beer-Lambert's law,

$$I = {I}_{0} {exp}^{- x / MFP}$$

$$⇒ M F P = - \frac{x}{ln ( \frac{I}{{I}_{0}} )}$$

$$⇒ M F P = - \frac{x}{ln ( \frac{{I}_{w 2} / {I}_{02}}{{I}_{w 1} / {I}_{01}} )}$$

$$⇒ M F P = - \frac{27}{ln ( \frac{38.99}{81.1012} )}$$

$$⇒ M F P = 36.8 \; 655 cm$$

Here, the mean free path is around 37 cm.

For the number density we take an elaborate route using the Mie scattering theory. In this case, the attenuation coefficient of the water can be calculated by using the measured intensities and the Beer-Lambert's law,

$$I = {I}_{0} {exp}^{- {L}_{w} α}$$

$$⇒ {L}_{w} = - \frac{1}{α} ln ( \frac{I}{{I}_{0}} )$$

$$⇒ α = - \frac{1}{{L}_{w}} ln ( \frac{{I}_{w 2} / {I}_{02}}{{I}_{w 1} / {I}_{01}} )$$

Here, L_{w}=water tank length=27 cm

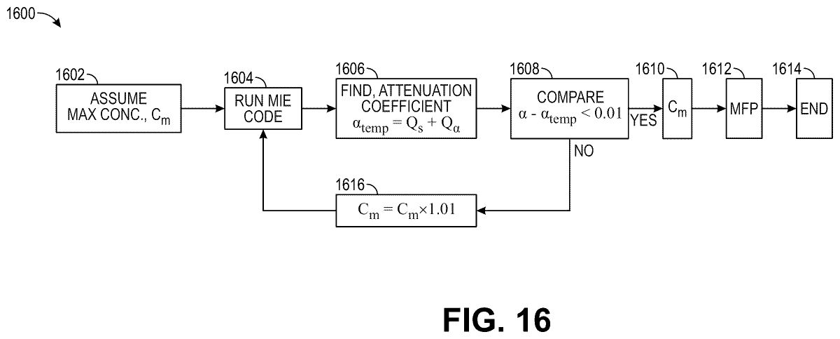

So, with this attenuation coefficient and using the Mie theory, the number density is used to produce the calculated attenuation coefficient can be calculated by running the Mie code obtained from C. Matzler, MATLAB functions for Mie scattering and absorption. IAP Res Rep. 8 (2002), which is hereby incorporated by reference in its entirety, by assuming different maximum particle concentration for the size distribution found in DLS measurement. The attenuation coefficient can be calculated for different particle concentration and compared with the attenuation coefficient calculated from the measurement. The code (process) is stopped when the attenuation coefficient matches with the calculated coefficient. The process is illustrated in FIG. 16. The MFP can also be calculated from this process and compared with the one that was calculated before to verify the process. In this process, the particle refractive index is assumed to be 1.572 (silica) and water refractive index is assumed to be 1.33.

FIG. 16 shows a calculation process flow 1600 to obtain the particle density according to examples of the present disclosure. The calculation process flow 1600 begins by assuming max conc., Cₘ at 1602. The calculation process flow 1600 continues by running Mie code at 1604. The calculation process flow 1600 continues by finding an attenuation coefficient αₜₑₘₚ=Qₛ+Q_{α} at 1606. The calculation process flow 1600 continues by comparing α−αₜₑₘₚ<0.01 at 1608. If the result of the comparison at 1608 is positive, the calculation process flow 1600 continues by outputting Cₘ at 1610, MFP at 1612, and process ends at 1614. If the results of the comparison at 1608 is negative, the calculation process flow 1600 continues by determining Cₘ by using Cₘ=Cₘ×1.01 at 1616 and then proceeding back to 1604.

### Monte Carlo Simulation of Light Inside Turbid Water

Light travel in water is highly dependent on turbidity or relative clarity of the water body. Turbidity is dependent on the presence of different types of scatterer particles in water. The more the scatterer the more turbid the water. Increased turbidity increases the probability of multiple scattering of light. Which (multiple scattering) is not very prominent in skylight due to the small amount of scatterer density in air. So, Monte Carlo method is used to handle the multiple scattering of light, which is very prominent in turbid water.

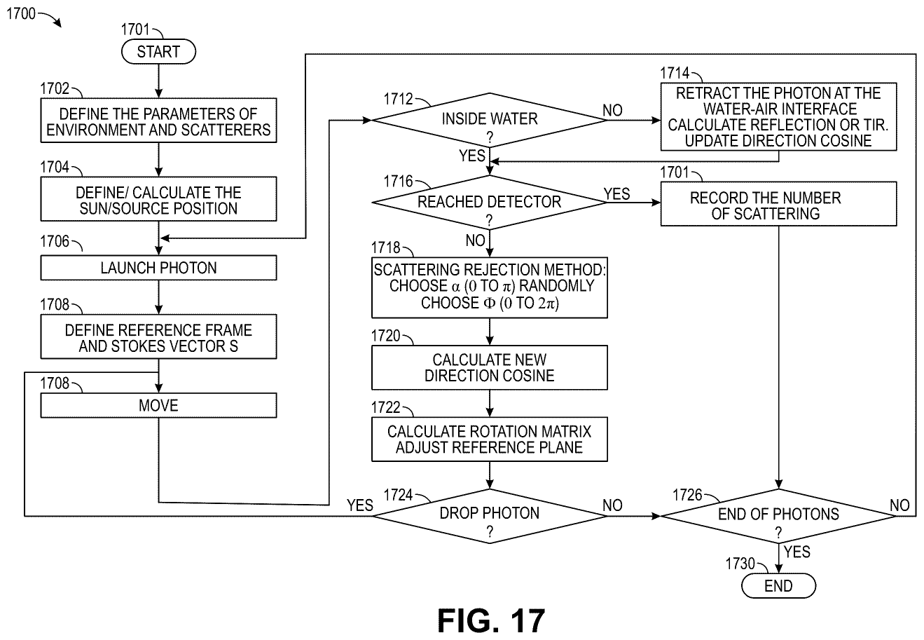

FIG. 17 shows a flow chart 1700 of a method of different processes to simulate the polarization mapping from sunlight scattering in underwater with MC Simulation according to examples of the present disclosure. The method starts at 1701 and the method continues by defining the parameters of environment and scatterers at 1702. The method continues by defining/calculating the sun/source position at 1704. The method continues by launching photon at 1706. The method continues by defining reference frame and Stokes vector S at 1708. The method continues by performing a move operation at 1710. The method continues by determining whether inside water at 1712. If the results of the determination at 1712 is negative, the method continues by retracting the photon at the water-air interface, calculating reflection or TIR, and updating direction cosine at 1714 and then proceed to 1716. If the results of the determination at 1712 is positive, the method continues by determining if the detector has been reached at 1716. If the results of the determination at 1716 is negative, the method continues by determining scattering using a rejection method by choosing α from 0 to π and randomly choosing Φ from 0 to 2π at 1718. The method continues by calculating a new direction cosine at 1720. The method continues by calculating a rotation matrix and adjusting a reference plane at 1722. The method continues by determining whether to drop a photon at 1724. If the result of the determination at 1724 is positive, the method continues by progressing to 1710. If the result of the determination at 1724 is negative, the method continues by making a determination that the photons are ended at 1726. If the result of the determination at 1716 is positive, the method continues by recording the number of scattering at 1728 and then the method continues by progressing to 1726. If the results of the determination at 1726 is negative, then the method continues by progressing back to 1706. If the results of the determination at 1726 is positive, then the method ends at 1730.

The polarized MC simulation steps are presented in FIG. 14. The simulation starts by launching a photon from the sun's position. With respect to the meridian plane of the traveling photon, an initial reference frame and the initial stokes parameters are defined. This part is the same for all the photons, as they all come from the sun's position in the sky.

Photons are moved and they do not get scattered in the air, but are refracted in the air-water interface and becomes partially polarized. After entering water body, the light may get scattered depending on the depth of the measurement. If the depth is very large, then the light is scattered more; if the depth is not large (comparable or smaller than the mean free path of the photon), then it may or may not get scattered.

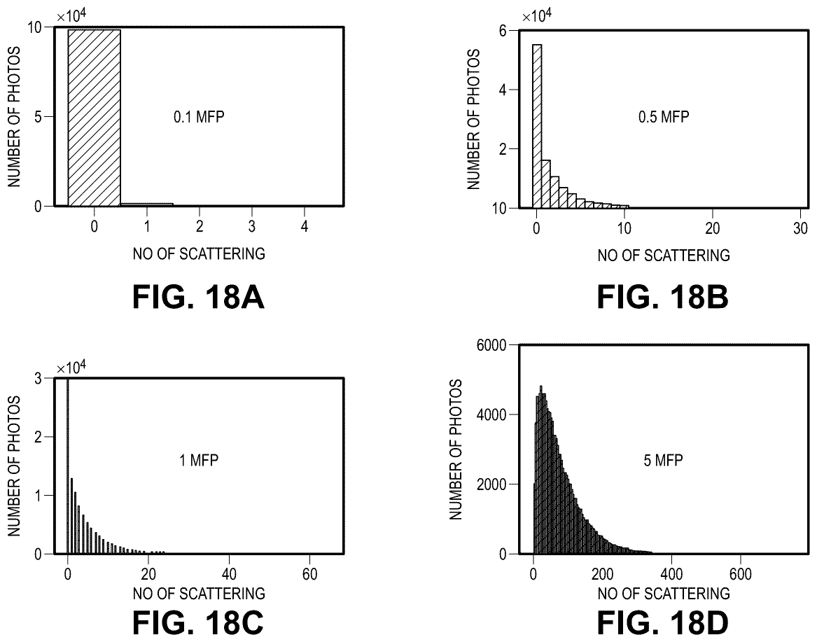

FIG. 18A, FIG. 18B, FIG. 18C, and FIG. 18D show plots of the number of photons versus number of scattering according to examples of the present disclosure considering polystyrene particles (index, N=1.572) of radius 400 nm and concentration 1.1770e+12m⁻³, number of scatterings for different depth of water indicated in terms of Mean Free Path (MFP), where FIG. 18A shows 0.1 MFP, FIG. 18B shows 0.5 MFP, FIG. 18C shows 1.0 MFP, and FIG. 18D shows 5.0 MFP. For the Particle Size and Concentration Used in the Simulation, the Mean Free Path (MFP) is 70 cm.

When in the water, the light can get scattered a random number of times (within 0 to some preset number). For each scattering event, the reference frame of the scattered photon is tracked and the polarization state after the scattering is calculated. For each scattering event, the scattering angle and the rotation angle from the scattering phase function of mie scatterers with the help of the rejection method (J. C. Ramella-Roman, S. A. Prahl, S. L. Jacques, Three Monte Carlo programs of polarized light transport into scattering media: part I. Opt. Express. 13, 4420 (2005).), which is hereby incorporated by reference in its entirety, are randomly chosen. After the stokes parameter of the scattered light is found, the stokes parameter can be multiplied with the scattering albedo to account for the scattering and absorption coefficient of the medium. Once this calculation is done for enough photons, then the mapping of the polarization components of light in the water can be determined. For example, 100,000 photons can be used for this calculation.

Using the Monte Carlo algorithm, an ensemble of photons can be simulated for how many of them will scatter how many times for different depths of water. It is clearly depicted in the figures. In this depiction, polystyrene particles (index, n=1.572) of radius 400 nm and concentration 1.1770e+12m⁻³ are considered. It can be seen that for shallow water, the light encounters almost no scattering events (zero scattering), but for deeper water, the photons scatter many times.

As the particle size density is used to determine the number of scattering and the probability of each scattering event, the particle size distribution in lake water with DLS (Dynamic Light Scattering) is measured. But DLS measurement does not provide the number density for each particle size. To obtain the number density for each size of the particles, two pieces of information are used, one, the mean free path of the water, and two, the size distribution of the particles. The second one is obtained from DLS measurements and the mean free path of the lake water is calculated by measuring the change of light intensity when it goes through the lake water. So, during experiments that were conducted, water was collected during the measurement and mean-free path measurements were made in the lab. It is detailed in further below.

After going through these calculations, the PSD with the number density can be obtained, as illustrated in FIG. 15A. Furthermore, the light scattering probability and the number of scattering for 1 MFP depth of the water can be calculated with the help of Monte Carlo algorithm explained above, illustrated in FIG. 15B.

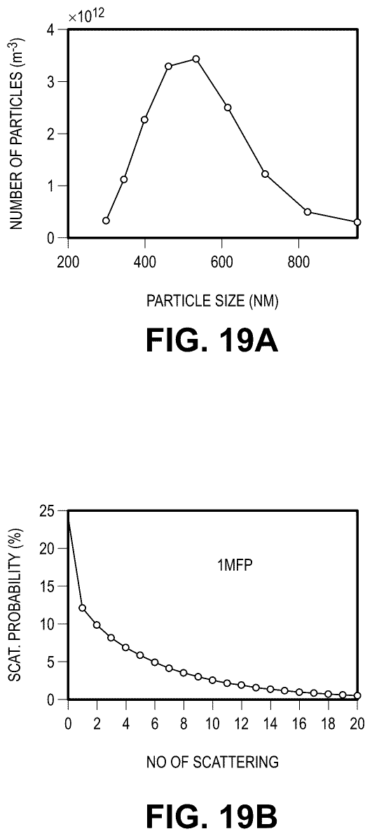

FIG. 19A shows a plot for particle size distribution and number density in Tempe Town lake water and FIG. 19B shows a plot for scattering probability vs. number of scattering for 1 MFP depth of water according to examples of the present disclosure.

### SMS: Single and Multiple Scattering Model

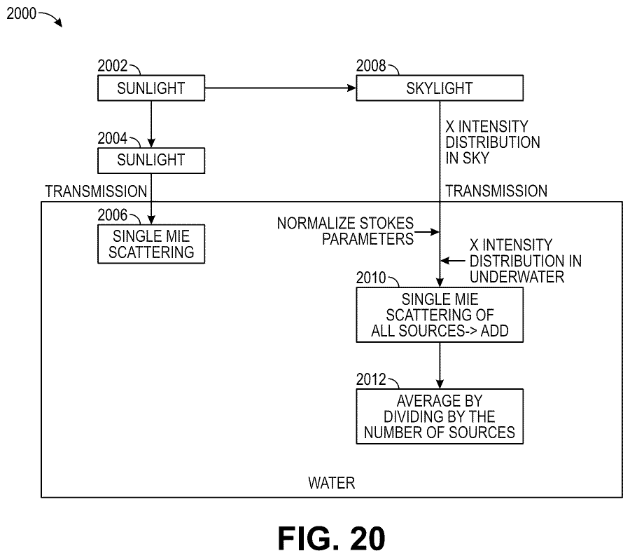

Underwater light scattering is a random process that depends on the sun's position, refractive index ratio of scatterer and water, scatterer's size, scatterer concentration, and water depth. This real-world random process can be emulated with the help of the Monte Carlo method described in J. C. Ramella-Roman, S. A. Prahl, S. L. Jacques, Three Monte Carlo programs of polarized light transport into scattering media: part I. Opt. Express. 13, 4420 (2005), J. C. Ramella-Roman, S. A. Prahl, S. L. Jacques, Three Monte Carlo programs of polarized light transport into scattering media: part II. Opt. Express. 13, 10392 (2005), R. A. Leathers, T. V. Downes, C. O. Davis, C. D. Mobley, “Monte Carlo Radiative Transfer Simulations for Ocean Optics: A Practical Guide: ” (Defense Technical Information Center, Fort Belvoir, VA, 2004), doi:10.21236/ADA426624, S. A. Prahl, “A Monte Carlo model of light propagation in tissue” in, G. J. Mueller, D. H. Sliney, R. F. Potter, Eds. (Berlin, Germany, 1989; https://protect.checkpoint.com/v2/r01/______http://proceedings.spiedigitallibrary.org/proceeding.aspx?doi=10.1117/12.2283590______.YzJ1Om1oMnRlY2hub2xvZ3lsYXdncm91cDpjOm86MTMwMGNhMjllNzI0YTFmNThjNzRjMDQ2MWViYTJhZDc6Nzo5MWU40jllZDQ0ZmEzZjU0YzFmZmM1ZWYzYzNjMzU0ZTAzMzhkMDdmYmQ5OTRiNjIzYjExN2NmNWE5ZmUwZjI1NDg2OTM6dDpUOkY), p. 1030509, H. H. Tynes, G. W. Kattawar, E. P. Zege, I. L. Katsev, A. S. Prikhach, L. I. Chaikovskaya, Monte Carlo and multicomponent approximation methods for vector radiative transfer by use of effective Mueller matrix calculations. Appl. Opt. 40, 400 (2001), and M. Xu, Electric field Monte Carlo simulation of polarized light propagation in turbid media. Opt. Express. 12, 6530 (2004), all hereby incorporated by reference in their entirety. An illustration of the detailed Monte Carlo flowchart is presented in the figures. In addition, a detailed calculation method of the mathematical model is presented in FIG. 20.

FIG. 20 shows a flowchart 2000 for a detailed calculation method of the mathematical model to describe turbid water light polarization according to examples of the present disclosure. For sunlight incident onto earth surface, there are two possible paths, i.e., a portion of sunlight passing through the earth atmosphere without being scattered and the rest getting scattered by molecules in the earth atmosphere, resulting in skylight. The method includes both path in the simulation. For the incident sunlight that is not scattered in the earth's atmosphere, the method begins obtaining sunlight incident onto the earth's atmosphere at 2002. The method continues by obtaining sunlight passing the atmosphere and reaching the water-air interface without being scattered at 2004. The method continues by determining single Mie scattering in water at 2006. For the incident light that is scattered in the earth's atmosphere and become skylight, the method continues by obtaining sunlight into earth's atmosphere at 2002 to skylight at 2008 by Rayleigh scattering where light intensity distribution in sky is determined. The method continues by obtaining light transmission from air into water and determining light intensity distribution in underwater. The method continues by determining single Mie scattering of all sources by particles of size distribution and density in the water at 2010. The method continues by averaging by dividing by the number of sources at 2012.

### Skylight Scattering Inside Water:

Stokes parameter of light after skylight (coming from different zenith and azimuth angle) gets scattered,

$${S}_{sky \_ scat} ( θ , φ ) = {\int }_{p = 1}^{N} {\int }_{{φ}^{′} = 0}^{2 π} {{\int }_{{θ}^{′} = 0}}^{\frac{π}{2}} {P}_{p} {M}^{p} ( θ , φ , {θ}^{′} , {φ}^{′} ) {S}_{Sky \_ refract} ( {θ}^{′} , {φ}^{′} ) d {θ}^{′} d {φ}^{′} dn$$

$$= {\sum }_{p = 1}^{N} {\sum }_{{ϕ}^{′} = 0}^{2 π} {\sum }_{{θ}^{′} = 0}^{\frac{π}{2}} {P}_{p} {M}^{p} ( θ , φ , {θ}^{′} , {φ}^{′} ) {S}_{Sky \_ refract} ( {θ}^{′} , {φ}^{′} )$$

$$= {\sum }_{p = 1}^{N} {\sum }_{{ϕ}^{′} = 0}^{2 π} {\sum }_{{θ}^{′} = 0}^{\frac{π}{2}} {P}_{p} [ R ( {σ}^{′} ) \{ M ( θ , φ , {θ}^{′} , {φ}^{′} , p ) ( R ( σ ) {S}_{Sky \_ refract} ( {θ}^{′} , {φ}^{′} ) ) \} ]$$

Here, S_{sky_refract}(θ′, φ′)=Stokes parameters of Skylight sources for different zenith and azimuth angles; S_{sky_scat}(θ, φ)=Stokes parameters after skylight scattering inside the water; Pₚ=Scattering probability for each size of particles; p=Pseudo particle size; M(θ, φ, θ′, φ′, p)=M(μ, p)=Muller Matrices for each particle size; R(σ′) and R(σ) are the rotation matrices; and μ=scattering angle.

### Also,

$$M ( μ , p ) = [ \begin{matrix}{M}_{11} ( μ , p ) & {M}_{12} ( μ , p ) & 0 & 0 \\ {M}_{21} ( μ , p ) & {M}_{22} ( μ , p ) & 0 & 0 \\ 0 & 0 & {M}_{33} ( μ , p ) & {M}_{34} ( μ , p ) \\ 0 & 0 & {M}_{43} ( μ , p ) & {M}_{44} ( μ , p )\end{matrix} ]$$

$$[ \begin{matrix}{M}_{11} ( μ , p ) & {M}_{12} ( μ , p ) & 0 & 0 \\ {M}_{12} ( μ , p ) & {M}_{11} ( μ , p ) & 0 & 0 \\ 0 & 0 & {M}_{33} ( μ , p ) & {M}_{34} ( μ , p ) \\ 0 & 0 & - {M}_{34} ( μ , p ) & {M}_{33} ( μ , p )\end{matrix} ]$$

$$Where , {M}_{11} = {M}_{22} = \frac{1}{2} ( {\vert {m}_{1} \vert}^{2} + {\vert {m}_{2} \vert}^{2} ) ; {M}_{12} = {M}_{21} = \frac{1}{2} ( {\vert {m}_{2} \vert}^{2} + {\vert {m}_{1} \vert}^{2} ) ;$$

$${M}_{33} = {M}_{44} = \frac{1}{2} ( {m}_{1} * {m}_{2} + {m}_{1} {m}_{2} \text{*)} ; and$$

$${M}_{34} = - {M}_{43} = i \frac{1}{2} ( {m}_{1} * {m}_{2} - {m}_{1} {m}_{2} * ) .$$

Here, m₁ and m₂ are the scattering functions representing the far-field solution of maxwell's equations. They were obtained using the Mie theory (C. F. Bohren, D. R. Huffman, Absorption and Scattering of Light by Small Particles (John Wiley & Sons, 2008).

### Sunlight Scattering Inside Water:

Sunlight refracts inside water, and that refracted sunlight is scattered. Stokes parameter,

$${S}_{sun \_ scat} ( θ , φ ) = {\int }_{p = 1}^{N} {P}_{p} {M}^{p} ( θ , φ , {θ}_{sun} , {φ}_{sun} ) {S}_{sun \_ refract} ( {θ}_{sun \_ refract} , {φ}_{sun} ) dn$$

$$= {\sum }_{p = 1}^{N} {P}_{p} {M}^{p} ( θ , φ , {θ}_{sun} , {φ}_{sun} ) {S}_{Sun} ( {θ}_{sun \_ refract} , {φ}_{sun} )$$

$$= {\sum }_{p = 1}^{N} {P}_{p} [ R ( {σ}^{′} ) \{ M ( θ , φ , {θ}_{sun} , {φ}_{sun} , p ) ( R ( σ ) {S}_{Sun} ( {θ}_{sun \_ refract} , {φ}_{sun} ) ) \} ]$$

Here, S_{sun_refract}(θ_{sun_refract}, φₛᵤₙ)=Stokes parameters of sunlight after refracting inside water and S_{sun_scat}(θ, φ)=Stokes parameters after sunlight scattering inside water.

In one or more embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

The examples set forth herein represent the necessary information to enable those skilled in the art to practice the embodiments and illustrate the best mode of practicing the embodiments. Upon reading the description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

What is claimed is:

1. A polarization-based underwater navigation and global positioning system comprising:
dual polarization cameras comprising a small angle view imaging lens configured to detect full Stokes parameters simultaneously; and
a computer system programmed with a model for a skylight polarization mapping with a scattering model of light inside turbid water.

2. The polarization-based underwater navigation and global positioning system of claim 1, wherein the model for the skylight polarization mapping comprises information related to an impact of scatterers on a polarization-position analysis to minimize a location measurement error.

3. The polarization-based underwater navigation and global positioning system of claim 1, wherein the small angle view imaging lens of the dual polarization cameras is configured to provide for reduced polarization aberration.

4. The polarization-based underwater navigation and global positioning system of claim 1, wherein a camera exposure of the dual polarization cameras is automatically adjusted during mapping.

5. The polarization-based underwater navigation and global positioning system of claim 1, further comprising an attitude and heading reference system (AHRS) and an inertial measurement unit (IMU) in communication with the dual polarization cameras and the computer system, wherein the IMU comprises microelectromechanical (MEMS) inertial sensor to measure an angular rate, an acceleration, and the Earth's magnetic field.

6. The polarization-based underwater navigation and global positioning system of claim 5, further comprising a robotic arm comprising two degrees of freedom, wherein the two degrees of freedom comprises an elevation arm movement of an elevation arm that covers a zenith angle from 0° to 90° and a rotation base arranged beneath the elevation arm to provides for rotation angle of 360° for azimuth scanning.

7. The polarization-based underwater navigation and global positioning system of claim 6, wherein the dual polarization cameras are mounted side-by-side on the elevation arm.

8. The polarization-based underwater navigation and global positioning system of claim 1, wherein each camera of the dual polarization cameras has a small field of view (FOV) of 14.3°×10.8°.

9. The polarization-based underwater navigation and global positioning system of claim 6, further comprising an industrial attitude and heading reference system (AHRS) that is mounted nearby to the dual polarization cameras to indicate a camera pointing direction with respect to geographic north.

10. The polarization-based underwater navigation and global positioning system of claim 1, wherein the dual polarization cameras comprise a linear polarization (LP) camera and a circular polarization (CP) camera.

11. The polarization-based underwater navigation and global positioning system of claim 9, wherein the computer system functions as a local control unit for rotation of the robotic arm, controls imaging of the dual polarization camera, and control reading from the AHRS.

12. The polarization-based underwater navigation and global positioning system of claim 6, further comprising an underwater housing that houses the dual polarization cameras, the computer system, the AHRS, the IMU, the MEMS inertial sensor, the AHRS, the robotic arm.

13. The polarization-based underwater navigation and global positioning system of claim 12, wherein the underwater housing comprises a 14-inch diameter transparent half-sphere dome for upwards imaging.

14. A polarization-based underwater navigation and global positioning system comprising:
a linear polarization (LP) camera and a circular polarized (CP) camera, wherein each LP camera and CP camera comprising a small angle view imaging lens configured to detect full Stokes parameters simultaneously;
an attitude and heading reference system (AHRS) and an inertial measurement unit (IMU), wherein the IMU comprises microelectromechanical (MEMS) inertial sensor to measure an angular rate, an acceleration, and the Earth's magnetic field;
a robotic arm comprising two degrees of freedom, wherein the two degrees of freedom comprises an elevation arm movement of an elevation arm that covers a zenith angle from 0° to 90° and a rotation base arranged beneath the elevation arm to provides for rotation angle of 360° for azimuth scanning;
an industrial attitude and heading reference system (AHRS) that is mounted nearby to the dual polarization cameras to indicate a camera pointing direction with respect to geographic north;
a computer system programmed with a model for a skylight polarization mapping with a scattering model of light inside turbid water; and
an underwater housing that houses the dual polarization cameras, the computer system, the AHRS, the IMU, the MEMS inertial sensor, the AHRS, the robotic arm.

15. The polarization-based underwater navigation and global positioning system of claim 14, wherein the LP camera and the CP camera are mounted side-by-side on the elevation arm.

16. The polarization-based underwater navigation and global positioning system of claim 14, wherein LP camera and the CP camera have a small field of view (FOV) of 14.3°×10.8°.

17. The polarization-based underwater navigation and global positioning system of claim 14, wherein the underwater housing comprises a 14-inch diameter transparent half-sphere dome for upwards imaging.
